(19) United States
(12) Patent Application Publication
(10) Pub. No.: US 2026/0223231 A1
(43) Pub. Date: Jul. 30, 2026

(54) METHODS AND APPARATUSES FOR ENHANCING MOBILITY IN WIRELESS COMMUNICATION SYSTEMS

(71) Applicant: SHARP KABUSHIKI KAISHA, Sakai City, Osaka (JP)

(72) Inventors: MEI-JU SHIH, Taipei (TW); CHIA-HUNG LIN, Taipei (TW); WAN-CHEN LIN, Taipei (TW)

(21) Appl. No.: 19/148,558

(22) PCT Filed: Jan. 17, 2024
(86) PCT No.: PCT/CN2024/072860

§ 371 Date: Jul. 16, 2025

Related U.S. Application Data
(60) Provisional application No. 63/439,368, filed on Jan. 17, 2023.

(51) Int. Cl. H04W 76/19; H04W 74/0833; H04W 76/27

(52) U.S. Cl. CPC H04W 76/19; H04W 74/0833; H04W 76/27

(57) ABSTRACT

Methods and apparatuses for enhancing mobility in wireless communication systems are provided. The method includes receiving a Radio Resource Control (RRC) reconfiguration message from a source cell, the RRC reconfiguration message including a timer value; starting a timer with the timer value upon receiving the RRC reconfiguration message; receiving a Layer 1/Layer 2 Triggered Mobility (LTM) cell switch command Medium Access Control (MAC) Control Element (CE) from the source cell after receiving the RRC reconfiguarion message, the LTM cell (UL) carrier types associated with a target cell; performing a cell switch during an LTM procedure according to the LTM cell switch command MAC CE and a configuartion in the RRC reconfiguration message; stopping the time in a case that the cell switch in the LTM procedure completes successfully; and initiating an RRC reestablishment procedure in a case that the time expires.

### CROSS-REFERENCE TO RELATED APPLICATION(S)

The present disclosure claims the benefit of and priority to U.S. Provisional Patent Application Ser. No. 63/439,368, filed on Jan. 17, 2023, entitled “METHOD AND APPARATUS FOR FAILURE HANDLING IN LIL2 TRIGGERED MOBILITY,” the content of which is hereby incorporated herein fully by reference into the present disclosure for all purposes.

### FIELD

The present disclosure is related to wireless communication and, more specifically, to methods and apparatuses for enhancing mobility in wireless communication systems.

### BACKGROUND

Various efforts have been made to improve different aspects of wireless communication for cellular wireless communication systems, such as 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to methods and apparatuses for enhancing mobility in wireless communication systems.

According to a first aspect of the present disclosure, a method performed by a User Equipment (UE) for enhancing mobility is provided. The method includes receiving a Radio Resource Control (RRC) reconfiguration message from a source cell, the RRC reconfiguration message including a timer value; starting a timer with the timer value upon receiving the RRC reconfiguration message; receiving a Layer 1/Layer 2 Triggered Mobility (LTM) cell switch command Medium Access Control (MAC) Control Element (CE) from the source cell after receiving the RRC reconfiguration message, the LTM cell switch command MAC CE including a target configuration Identity (ID) and Uplink (UL) carrier types associated with a target cell; performing a cell switch during an LTM procedure according to the LTM cell switch command MAC CE and a configuration in the RRC reconfiguration message; stopping the timer in a case that the cell switch in the LTM procedure completes successfully; and initiating an RRC re-establishment procedure in a case that the timer expires.

In some implementations of the first aspect of the present disclosure, the LTM cell switch command MAC CE further includes at least one of the following: a Random Access (RA) preamble index field; information associated with a contention-free RA resource for a 4-step RA type; Timing Advance (TA) information; and information of a Transmission Configuration Indicator (TCI) state associated with the target cell.

In some implementations of the first aspect of the present disclosure, the TCI state is one of a Downlink (DL) TCI state, an UL TCI state, and a joint TCI state.

In some implementations of the first aspect of the present disclosure, the method further includes retaining the configuration in the RRC reconfiguration message after the LTM procedure completes successfully; and performing a subsequent LTM procedure according to the configuration in the RRC reconfiguration message after the LTM procedure.

In some implementations of the first aspect of the present disclosure, the method further includes performing a cell reselection procedure in a case that the LTM procedure fails.

In some implementations of the first aspect of the present disclosure, the method further includes transitioning to an RRC_IDLE state in a case that the LTM procedure fails.

In some implementations of the first aspect of the present disclosure, the method further includes performing a Random Access (RA) procedure with the target cell during the LTM procedure; and determining that the cell switch in the LTM procedure completes successfully in a case that the RA procedure completes successfully.

In some implementations of the first aspect of the present disclosure, performing the RA procedure with the target cell includes performing the RA procedure with the target cell on an UL carrier indicated by the UL carrier types.

In some implementations of the first aspect of the present disclosure, the method further includes determining that the cell switch in the LTM procedure completes successfully in a case that the UE receives Downlink (DL) signaling from the target cell.

According to a second aspect of the present disclosure, a User Equipment (UE) for enhancing mobility is provided. The UE includes at least one processor and at least one memory coupled to the at least one processor. The at least one memory stores one or more computer-executable instructions that, when executed by the at least one processor, cause the UE to receive a Radio Resource Control (RRC) reconfiguration message from a source cell, the RRC reconfiguration message including a timer value; start a timer with the timer value upon receiving the RRC reconfiguration message; receive a Layer 1/Layer 2 Triggered Mobility (LTM) cell switch command Medium Access Control (MAC) Control Element (CE) from the source cell after receiving the RRC reconfiguration message, the LTM cell switch command MAC CE including a target configuration Identity (ID) and Uplink (UL) carrier types associated with a target cell; perform a cell switch during an LTM procedure according to the LTM cell switch command MAC CE and a configuration in the RRC reconfiguration message; stop the timer in a case that the cell switch in the LTM procedure completes successfully; and initiate an RRC re-establishment procedure in a case that the timer expires.

In some implementations of the second aspect of the present disclosure, the LTM cell switch command MAC CE further includes at least one of the following: a Random Access (RA) preamble index field; information associated with a contention-free RA resource for a 4-step RA type; Timing Advance (TA) information; and information of a Transmission Configuration Indicator (TCI) state associated with the target cell.

In some implementations of the second aspect of the present disclosure, the TCI state is one of a Downlink (DL) TCI state, an UL TCI state, and a joint TCI state.

In some implementations of the second aspect of the present disclosure, the one or more computer-executable instructions, when executed by the at least one processor, further cause the UE to retain the configuration in the RRC reconfiguration message after the LTM procedure completes successfully; and perform a subsequent LTM procedure according to the configuration in the RRC reconfiguration message after the LTM procedure.

In some implementations of the second aspect of the present disclosure, the one or more computer-executable instructions, when executed by the at least one processor, further cause the UE to perform a cell reselection procedure in a case that the LTM procedure fails.

In some implementations of the second aspect of the present disclosure, the one or more computer-executable instructions, when executed by the at least one processor, further cause the UE to transition to an RRC_IDLE state in a case that the LTM procedure fails.

In some implementations of the second aspect of the present disclosure, the one or more computer-executable instructions, when executed by the at least one processor, further cause the UE to perform a Random Access (RA) procedure with the target cell during the LTM procedure; and determine that the cell switch in the LTM procedure completes successfully in a case that the RA procedure completes successfully.

In some implementations of the second aspect of the present disclosure, performing the RA procedure with the target cell includes performing the RA procedure with the target cell on an UL carrier indicated by the UL carrier types.

In some implementations of the second aspect of the present disclosure, the one or more computer-executable instructions, when executed by the at least one processor, further cause the UE to determine that the cell switch in the LTM procedure completes successfully in a case that the UE receives Downlink (DL) signaling from the target cell.

According to a third aspect of the present disclosure, a Base Station (BS) for enhancing mobility is provided. The BS includes at least one processor and at least one memory coupled to the at least one processor. The at least one memory stores one or more computer-executable instructions that, when executed by the at least one processor, cause the BS to transmit a Radio Resource Control (RRC) reconfiguration message including a timer value to a User Equipment (UE), enabling the UE to start a timer with the timer value upon receiving the RRC reconfiguration message; and transmit a Layer 1/Layer 2 Triggered Mobility (LTM) cell switch command Medium Access Control (MAC) Control Element (CE) to the UE after transmitting the RRC reconfiguration message, enabling the UE to perform a cell switch during an LTM procedure according to the LTM cell switch command MAC CE and a configuration in the RRC reconfiguration message; stop the timer in a case that the cell switch in the LTM procedure completes successfully; and initiate an RRC re-establishment procedure in a case that the timer expires. The LTM cell switch command MAC CE includes a target configuration Identity (ID) and Uplink (UL) carrier types associated with a target cell.

In some implementations of the third aspect of the present disclosure, the LTM cell switch command MAC CE further includes at least one of the following: a Random Access (RA) preamble index field; information associated with a contention-free RA resource for a 4-step RA type; Timing Advance (TA) information; and information of a Transmission Configuration Indicator (TCI) state associated with the target cell.

In some implementations of the third aspect of the present disclosure, the TCI state is one of a Downlink (DL) TCI state, an UL TCI state, and a joint TCI state.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart of a method for enhancing mobility, according to an example implementation of the present disclosure.

FIG. 2 is a flowchart of a method for enhancing mobility, according to an example implementation of the present disclosure.

FIG. 3 is a diagram illustrating the signaling exchange between a UE and a source cell for an LTM procedure, according to an example implementation of the present disclosure.

FIG. 4 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| ARFCN | Absolute Radio-Frequency Channel Number |
| AS | Access Stratum |
| ASN.1 | Abstract Syntax Notation One |
| BS | Base Station |
| BWP | Bandwidth Part |
| C-RNTI | Cell-RNTI |
| CA | Carrier Aggregation |
| CAG | Closed Access Group |
| CG | Configured Grant |
| CHO | Conditional Handover |
| CJT | Coherent Joint Transmission |
| CN | Core Network |
| CORESET | Control Resource Set |
| CSI | Channel State Information |
| CS-RNTI | Configured Scheduling RNTI |
| CSS | Common Search Space |
| CSI-RS | Channel State Information-Reference Signal |
| CU | Central Unit |
| DAPS | Dual Active Protocol Stack |
| DC | Dual Connectivity |
| DCI | Downlink Control Information |
| DL | Downlink |
| DMRS | Demodulation Reference Signal |
| DRB | Data Radio Bearer |
| DU | Distributed Unit |
| E-UTRA | Evolved Universal Terrestrial Radio Access |
| EN-DC | E-UTRA NR Dual Connectivity |
| EPC | Evolved Packet Core |
| eMTC | Enhanced Machine Type Communication |
| eNB | Evolved Node B |
| FDD | Frequency Division Duplexing |
| FR1 | Frequency Range 1 |
| FR2 | Frequency Range 2 |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HARQ-ACK | Hybrid Automatic Repeat Request-Acknowledgement |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| L1 | Layer 1 |
| L2 | Layer 2 |
| L3 | Layer 3 |
| LAN | Local Area Network |
| LCID | Logical Channel Identity |
| LEO | Low Earth Orbit |
| LTE | Long Term Evolution |
| LTM | L1/L2-Triggered Mobility |
| MAC | Medium Access Control |
| MAC CE | MAC Control Element |
| MCG | Master Cell Group |
| MCS-C-RNTI | Modulation and Coding Scheme Cell RNTI |
| MIB | Master Information Block |
| MN | Master Node |
| MTC | Machine Type Communication |
| NACK | Negative Acknowledgement |
| NAS | Non-Access Stratum |
| NB-IoT | Narrow Band Internet of Things |
| NE-DC | NR-E-UTRA Dual Connectivity |
| NGEN-DC | NG-RAN E-UTRA-NR Dual Connectivity |
| ng-eNB | Next Generation Evolved NodeB |
| NG | Next Generation |
| NPN | Non-Public Network |
| NR | New Radio |
| NR-DC | New Radio-Dual Connectivity |
| NR-U | NR Unlicensed |
| NTN | Non-Terrestrial Network |
| NUL | Normal Uplink |
| NW | Network |
| OFDM | Orthogonal Frequency-Division Multiplexing |
| PBCH | Physical Broadcast Channel |
| PCell | Primary Cell |
| PCI | Physical Cell Identity |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PNI-NPN | Public Network Integrated Non-Public Network |
| PRACH | Physical Random Access Channel |
| PSCell | Primary Secondary Cell/Primary SCG Cell |
| PUCCH | Physical Uplink Control Channel |
| PUSCH | Physical Uplink Shared Channel |
| RA | Random Access |
| RACH | Random Access Channel |
| RACH-less | Random Access Channel-less |
| RAN | Radio Access Network |
| RAR | Random Access Response |
| RA-RNTI | Random Access-RNTI |
| RAT | Radio Access Technology |
| RF | Radio Frequency |
| RLC | Radio Link Control |
| RLF | Radio Link Failure |
| RS | Reference Signal |
| RSTD | Reference Signal Time Difference |
| RNTI | Radio Network Temporary Identifier |
| RO | RACH Occasion |
| RRC | Radio Resource Control |
| RS | Reference Signal |
| RSRP | Reference Signal Received Power |
| RSSI | Received Signal Strength Indication |
| RSRQ | Reference Signal Receiving Quality |
| SCell | Secondary Cell |
| SCG | Secondary Cell Group |
| SDT | Small Data Transmission |
| SFN | Single-Frequency Network |
| SI | System Information |
| SIB | System Information Block |
| SINR | Signal to Interference plus Noise Ratio |
| SL | Sidelink |
| SMTC | SSB-based Measurement Timing Configuration |
| SN | Secondary Node |
| SNPN | Stand-alone Non-Public Network |
| SpCell | Special Cell |
| SR | Scheduling Request |
| SRB1 | Signaling Radio Bearer 1 |
| SRB2 | Signaling Radio Bearer 2 |
| SRS | Sounding Reference Signal |
| SSB | Synchronization Signal Block |
| SUL | Supplementary Uplink |
| TA | Timing Advance |
| TAG | Timing Advance Group |
| TAT | Time Alignment Timer |
| TCI | Transmission Configuration Indication |
| TDD | Time Division Duplexing |
| TN | Terrestrial Network |
| TRP | Transmission Reception Point |
| TRS | Tracking Reference Signal |
| TS | Technical Specification |
| TX | Transmission |
| UCI | Uplink Control Information |
| UE | User Equipment |
| UL | Uplink |
| UL-CG | Uplink-Configured Grant |
| USIM | Universal Subscriber Identity Module |
| USS | UE-specific Search Space |
| V2X | Vehicle-to-Everything |
| VSAT | Very Small Aperture Terminal |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Multiple PLMNs may be operated on the unlicensed spectrum. Multiple PLMNs may share the same unlicensed carrier. The PLMNs may be public or private. Public PLMNs (e.g., provided by operators and/or virtual operators) may provide radio services to public subscribers. Public PLMNs may own licensed spectrum and also support radio access technology on the licensed spectrum. Private PLMNs (e.g., provided by micro-operators, factories, and/or enterprises) may provide radio services to their private users (e.g., employees or machines). In some implementations, public PLMNs may support more deployment scenarios. These scenarios may include carrier aggregation between licensed band NR (e.g., the PCell) and NR-U (e.g., the SCell), dual connectivity between licensed band LTE (e.g., the PCell) and NR-U (e.g., the PSCell), stand-alone NR-U, an NR cell with DL in the unlicensed band and UL in the licensed band, and dual connectivity between licensed band NR (e.g., the PCell) and NR-U (e.g., the PSCell). In some implementations, private PLMNs mainly support, but are not limited to, stand-alone unlicensed radio access technology, such as stand-alone NR-U.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

Examples of some selected terms in the present disclosure are provided as follows.

The terms “network (NW),” “cell,” “camped cell,” “serving cell,” “Base Station (BS),” “gNB,” “eNB” and “ng-eNB” may be used interchangeably. In some implementations, some of these items may refer to the same network entity.

The RAT may include, but is not limited to, NR, LTE, E-UTRA connected to 5GC, LTE connected to 5GC, E-UTRA connected to EPC, and LTE connected to EPC. The mechanisms, methods, approaches described in the present disclosure may be applicable to the UEs operating in the public networks or in the private networks (e.g., NPNs, SNPNs, and/or PNI-NPNs).

The mechanisms, methods, approaches described in the present disclosure may be applicable to the licensed frequency and/or the unlicensed frequency.

System information (SI) may refer to the MIB, the SIB1, or other SI. Minimum SI may include the MIB and the SIB1. Other SI may refer to SIB3, SIB4, SIB5, or other SIB(s).

Dedicated signaling may refer to, but is not limited to, one or more RRC messages. Examples of the RRC message(s) may include the RRC (Connection) Setup Request message, the RRC (Connection) Setup message, the RRC (Connection) Setup Complete message, the RRC (Connection) Reconfiguration message, the RRC Connection Reconfiguration message including the mobility control information, the RRC Connection Reconfiguration message without the mobility control information inside, the RRC Reconfiguration message including the configuration with sync, the RRC Reconfiguration message without the configuration with sync inside, the RRC (Connection) Reconfiguration Complete message, the RRC (Connection) Resume Request message, the RRC (Connection) Resume message, the RRC (Connection) Resume Complete message, the RRC (Connection) Reestablishment Request message, the RRC (Connection) Reestablishment message, the RRC (Connection) Reestablishment Complete message, the RRC (Connection) Reject message, the RRC (Connection) Release message, the RRC System Information Request message, the UE Assistance Information message, the UE Capability Enquiry message, and UE Capability Information message.

The mechanisms, methods, approaches described in the present disclosure may be applicable to the RRC_CONNECTED UE (e.g., the UE in the RRC_CONNECTED state), the RRC_INACTIVE UE (e.g., the UE in the RRC_INACTIVE state), and the RRC_IDLE UE (e.g., the UE in the RRC_IDLE state).

The UE may be served by a cell, e.g., a serving cell. The serving cell may serve an RRC_CONNECTED UE, among other types of UEs. The serving cell may be (but is not limited to) a suitable cell.

PCell (Primary Cell): an MCG cell, operating on the primary frequency, in which the UE either performs the initial connection establishment procedure or initiates the connection re-establishment procedure.

PSCell (Primary SCG Cell): an SCG cell used for dual connectivity operation, in which the UE may perform an RA procedure when performing the Reconfiguration with the synchronization (Sync) procedure.

Serving Cell: for a UE in the RRC_CONNECTED state not configured with CA/DC, there is only one serving cell consisting of the primary cell. For a UE in the RRC_CONNECTED state configured with CA/DC, the term “serving cells” is used to denote the set of cells consisting of the Special Cell(s) and all secondary cells.

Secondary Cell: for a UE configured with CA, the secondary cell may refer to the cell providing additional radio resources on top of the Special Cell.

Special Cell (SpCell): for the DC operation, the Special Cell may refer to the PCell of the MCG or the PSCell of the SCG, otherwise the Special Cell may refer to the PCell.

Master Cell Group (MCG): in MR-DC, the MCG may refer to a group of serving cells associated with the Master Node, consisting of the SpCell (e.g., the PCell) and optionally one or more SCells.

Master Node: in MR-DC, the master node may refer to the radio access node that provides the control plane connection to the core network. The master node may be a Master eNB (in EN-DC), a Master ng-eNB (in NGEN-DC), or a Master gNB (in NR-DC and NE-DC).

Secondary Cell Group (SCG): in MR-DC, the SCG may refer to a group of serving cells associated with the Secondary Node, consisting of the SpCell (e.g., the PSCell) and optionally one or more SCells.

Secondary node: in MR-DC, the secondary node may refer to the radio access node, with no control plane connection to the core network, providing additional resources to the UE. The secondary node may be an en-gNB (in EN-DC), a Secondary ng-eNB (in NE-DC) or a Secondary gNB (in NR-DC and NGEN-DC). en-gNB is a node providing NR user plane and control plane protocol terminations towards the UE, and acting as Secondary Node in EN-DC.

The terms “serving cell”, “TRP associated with the PCI of the serving cell”, “TRP associated with the serving cell”, “TRP of a serving cell” and “TRP of the serving cell” may be used interchangeably.

The term “target cell”, “target serving cell”, “TRP associated with a PCI different from the PCI of the serving cell”, and “TRP associated with the target cell” may be used interchangeably. A target serving cell may be identified by a PCI or a PCI index. A UE may be configured with at most 1, 4, 8, or 32 PCI indices. Each PCI index may identify a target serving cell of the UE.

The serving cell described in the present disclosure may refer to a PCell, an SCell or a PSCell.

The target cell described in the present disclosure may refer to a PCell, an SCell or a PSCell.

The inter-cell relative to the serving cell of the UE may refer to a neighboring cell, a cell other than the serving cell or a cell with a PCI different from the PCI of the serving cell. If the UE is capable of performing inter-cell beam managements, the UE may be in coverage of the inter-cell.

The term “MAC layer” and the term “MAC entity” may be used interchangeably.

The fact that the UE is configured with the unified TCI framework (e.g., the unified TCI configuration) may be equivalent to the fact that the UE is configured with the unified TCI state operation.

SpCellConfig: a special cell configuration including serving-cell-specific MAC and PHY parameters for a SpCell. These parameters may be applicable to the SpCell of a cell group (the PCell of the MCG or the PSCell of the SCG). The SpCellConfig may be included in a cell group configuration (e.g., the IE CellGroupConfig). The SpCellConfig may include a serving cell configuration (e.g., the IE ServingCellConfig).

SCellConfig: the SCellConfig may be included in the CellGroupConfig. The SCellConfig may include the ServingCellConfig.

ServingCellConfig: The IE ServingCellConfig may refer to a serving cell configuration used to configure (add or modify) the UE with a serving cell, which may be the SpCell or an SCell of an MCG or SCG. The parameters included in the ServingCellConfig are mostly UE-specific but partly also cell-specific (e.g., in additionally configured bandwidth parts). Reconfiguration between a PUCCH and a PUCCHless SCell is only supported using an SCell release and add.

CellGroupConfig: a cell group configuration of a cell group. For example, the IE CellGroupConfig may be used to configure the MCG or the SCG. A cell group may consist of one MAC entity, a set of logical channels with the associated RLC entities and of a primary cell (e.g., the SpCell) and one or more secondary cells (e.g., the SCell(s)).

The UE determining that the L1/L2 mobility enhancement fails may refer to at least one of the following situations: the RRC pre-configuration step fails, the cell switch fails, the L1 measurement and reporting fails, the DL synchronization fails, the UL synchronization fails, and the subsequent cell switch(es) fails.

The UE determining that the L1/L2 mobility enhancement completes successfully may refer to at least one of the following situations: the RRC pre-configuration step completes successfully, the cell switch completes successfully, the L1 measurement and reporting completes successfully, the DL synchronization completes successfully, the UL synchronization completes successfully, and the subsequent cell switch(es) completes successfully.

In some implementations, the source gNB/cell may refer to the gNB/cell that serves the UE when the UE receives the RRC message during the RRC pre-configuration step. For example, the source gNB/cell in the cell switch and the subsequent cell switch may refer to the same source gNB/cell. In some implementations, the source gNB/cell may refer to the gNB/cell that serves the UE before the UE switches to a new cell. For example, the source gNB/cell in the cell switch step and the source gNB/cell in the subsequent cell switch step may refer to different source gNBs/cells.

In some implementations, a previously selected target gNB/cell may refer to a selected target gNB/cell in a previous cell switch per RRC pre-configuration. For example, the UE may perform a first cell switch and a subsequent cell switch based on one RRC pre-configuration. The RRC pre-configuration may be provided to the UE by the source gNB/cell. The UE may select a selected target gNB/cell in the first cell switch. During the first cell switch, the UE may switch to the selected target gNB/cell from the source gNB/cell. During the subsequent cell switch, the selected target gNB/cell becomes the UE's previous selected target gNB/cell. During the subsequent cell switch, the UE may select another selected target gNB/cell and perform the subsequent cell switch to switch from the previous selected target gNB/cell to the another selected target gNB/cell.

In a wireless cellular network, mobile devices (e.g., UEs) may move from the coverage area of one cell to another cell. To avoid connection interruption and ensure service continuity, the HO procedure may be used by the mobile devices when the HO procedure is triggered under certain conditions, e.g., when the signal quality of the source cell becomes poorer than a threshold for a period.

In a typical wireless communication system, the HO procedure is triggered by L3 measurements and is completed by RRC-signaling-triggered Reconfiguration with Synchronization for change of the PCell and the PSCell and for release and addition of SCells. In addition, the CHO procedure (or “CHO”) may be used to enhance the robustness so that the mobile device receives the configuration of the target cell in advance, e.g., when the signal quality of the connection between the mobile device and the source cell is stable. Further, the DAPS HO procedure (or “DAPS”) may be used to reduce the interruption time since the mobile device is able to maintain two protocol stacks, e.g., one protocol stack is associated with the source cell and another protocol stack is associated with the target cell, for simultaneous connections with the source cell and the target cell during the HO.

In the typical wireless communication system, the HO procedure, the CHO procedure, and the DAPS HO procedure may require completing an L2 reset and an L1 reset. L2 may refer to the MAC layer, the RLC layer, and/or the PDCP layer. L1 may refer to the PHY layer. A complete L1/L2 reset may result in longer latency, larger overhead, and longer interruption time than beam switch mobility. Thus, it may be desirable to investigate L1/L2 mobility enhancement, e.g., enabling a serving cell change via L1/L2 signaling, to reduce the latency, overhead, and interruption time during the HO procedures.

L1/L2 mobility enhancement is targeted at reducing the latency, overhead, and interruption time due to UE mobility, e.g., by enabling a serving cell change via L1/L2 signaling, for the HO procedures. L1/L2 mobility enhancement may involve RRC pre-configuration of the information associated with the candidate target cells, L1 measurement and reporting, DL synchronization with the candidate target cells, UL synchronization with the candidate target cells, cell switch to the target cell, subsequent cell switch to target cells, etc. However, L1/L2 mobility enhancement may fail. In the present disclosure, mechanisms for the UE to identify failures and successes in L1/L2 mobility enhancement are provided. The present disclosure further outlines the procedures the UE follows in response to the failures, thereby achieving efficiency (e.g., signaling overhead reduction, energy-efficient) while maintaining reliability.

L1/L2 mobility enhancement may also refer to (but not limited to) an L1/L2-triggered Mobility (LTM) procedure. Generally, mobility enhancement from different perspectives and different protocol layers may be proposed to realize the LTM procedure. In some implementations, an LTM procedure may involve at least one of the following: the RRC pre-configuration step, the L1 measurement and reporting step, the DL synchronization step, the UL synchronization step, and the (subsequent) cell switch step.

In the present disclosure, the terms “LTM”, “L1/L2-triggered mobility” and “L1/L2 mobility enhancement” may be used interchangeably. The terms “RRC pre-configuration”, “RRC pre-configuration step”, “RRC preconfiguration”, “RRC preconfiguration step”, “RRC (pre) configuration”, and “RRC (pre) configuration step” may be used interchangeably. The terms “L1 measurement and reports,” “L1 measurement and reports step,” “L1 measurement and reporting” and “L1 measurement and reporting step” may be used interchangeably. The terms “DL synchronization” and “DL synchronization step” may be used interchangeably. The terms “UL synchronization” and “UL synchronization step” may be used interchangeably. The terms “cell switch” and “cell switch step” may be used interchangeably. The terms “subsequent cell switch” and “subsequent cell switch step” may be used interchangeably.

In the subsequent sections of the present disclosure, a comprehensive discussion of L1/L2 mobility enhancement is presented. These sections delve into various aspects of the L1/L2 mobility enhancement, including RRC pre-configuration, L1 measurement and reporting, DL synchronization, UL synchronization, cell switch, scenarios, failure determination, success determination, and failure handling. It is important to note that while each section addresses a distinct aspect of mobility enhancement, the content described should not be viewed as isolated. Instead, the content across these sections may be interrelated, collectively contributing to a broader understanding of the concept of mobility enhancement.

### RRC Pre-Configuration

During the RRC pre-configuration step, the source gNB/cell may transmit the information/configuration associated with the candidate target cells to the UE via RRC signaling. The source gNB/cell may (1) prepare one or multiple candidate target cells (for the LTM procedure and/or the HO), (2) generate the RRC message (e.g., the RRC Reconfiguration message) and/or the IE (e.g., the CellGroupConfig 1E, LTM-specific IE) including the information/configuration associated with the candidate target cells, and/or (3) transmit the generated RRC message (and/or the IE) to the UE. Upon receiving the information/configuration associated with the candidate target cells, the UE may store and/or apply the received information/configuration to perform the HO procedures (e.g., L1/L2-triggered mobility).

In some implementations, upon receiving the information/configuration associated with the candidate target cells, the UE may release the stored information/configuration associated with the candidate target cells, if any, and then store and/or use the newly received information/configuration associated with the candidate target cells. It is noted that the stored information/configuration associated with the candidate target cells may be included in the previous RRC message and/or the IE received by the UE from the source gNB/cell, where the RRC message and/or the IE may include the information/configuration associated with the candidate target cells.

In some implementations, upon receiving the information/configuration associated with the candidate target cells, the UE may release the stored information/configuration associated with a first set of candidate target cells, if any, and then store and/or use the newly received information/configuration associated with a second set of the candidate target cells. In some implementations, at least one candidate target cell in the first set of candidate target cells may be the same as at least one candidate target cell in the second set of candidate target cells. Certain candidate target cells in the first set of candidate target cells may be different from certain candidate target cells in the second set of candidate target cells. In some implementations, all candidate target cells in the first set of candidate target cells are different from those candidate target cells in the second set of candidate target cells. In some implementations, the source gNB/cell may determine the candidate target cells, e.g., in the first set of candidate target cells and the second set of candidate target cells, based on the network topology, network deployment, (L1/L3) measurement report from the UE, network configuration, etc.

In some implementations, upon receiving the information/configuration associated with the candidate target cells, the UE may release the stored information/configuration associated with a first set of candidate target cells, if any, and retain (not release) the stored information/configuration associated with a second set of candidate target cells. The UE may then store and/or use the newly received information/configuration associated with a third set of candidate target cells. In some implementations, the source gNB/cell may determine the candidate target cells, e.g., in the first set of candidate target cells, the second set of candidate target cells, or the third set of candidate target cells, based on the network topology, network deployment, (L1/L3) measurement report from the UE, network configuration, etc.

### L1 Measurement and Reporting

The UE may perform L1 measurement and reporting in the LTM procedure. Based on the measurement configuration, the UE may perform L1 measurement on the neighboring cells and/or on the candidate target cells. The UE may receive the measurement configuration from the source gNB/cell via RRC signaling. For example, the UE may receive the measurement configuration during, before, and/or after the RRC pre-configuration step. The UE may perform L1 measurement and reporting before or after the RRC pre-configuration step in the LTM procedure. The measurement configuration may include information/configuration that the UE requires to perform L1 measurement. The information/configuration that the UE requires to perform L1 measurement may include, but is not limited to, the reference resource configuration associated with the neighboring cells and/or the candidate target cells to be measured. For example, the UE may measure the received signal quality and/or the received signal strength on at least one of the reference resources or RSs (e.g., the SSBs, CSI-RSs, and/or TRSs) associated with the neighboring cells and/or the candidate target cells. In some implementations, the reference resource configuration may include the association between the at least one of the reference resources and the neighboring cells (and/or the candidate target cells). In some implementations, the measurement configuration may include the association between the at least one of the reference resources and the neighboring cells (and/or the candidate target cells).

The UE may report the L1 measurement results to the source gNB/cell, periodically, by event, after L1 measurements, or after an event is triggered. The UE may receive the report configuration from the source gNB/cell via RRC signaling, e.g., before, during, and/or after the RRC pre-configuration step. The UE may report the L1 measurement results to the source gNB/cell via RRC message and/or the lower-layer signaling (e.g., UCI). The UE may report the L1 measurement results to the source gNB/cell via a PUCCH, a PUSCH, and/or a MAC CE. The L1 measurement results may include, but not limited to, the RSRP values of the reference resources (associated with the neighboring cells and/or the candidate target cells to be measured) and/or the RSRQ values of the reference resources (associated with the neighboring cells and/or the candidate target cells to be measured). The UE may report the RSRP values of the reference resources (associated with the neighboring cells and/or the candidate target cells to be measured) and/or the RSRQ values of the reference resources (associated with the neighboring cells and/or the candidate target cells to be measured). The measurement results may be reported by the UE to the source gNB/cell, one or more candidate target cells configured to the UE for channel quality/strength measurement and report, and/or at least one of the candidate target cells determined in the RRC pre-configuration step. The report configuration may include the information of when the UE reports the L1 measurement results, a timer value (e.g., the duration for which the UE reports the measurement results at one time, the periodicity of reporting the measurement results), the information of resources on which the UE reports the L1 measurement results, the information of reference resources based on which the UE reports the L1 measurement results, etc.

The report configuration may include one or more threshold(s) for a UE to determine whether to transmit the L1 measurement report(s) corresponding to the measurement results of the reference resources associated with the neighboring cells and/or the candidate target cells to be measured, where the one or more threshold(s) may include at least one RSRP threshold value or at least one RSRQ threshold value.

In some implementations, the report configuration may include an RSRP threshold value. The UE may measure the RSRP value(s) of the reference resources associated with the neighboring cells and/or the candidate target cells. After the L1 measurement, the UE may report which neighboring cell and/or candidate target cell has a better channel condition (e.g., the measured RSRP value is larger than or equal to the RSRP threshold value) to the source gNB/cells and/or one or more candidate target cells. For example, the UE may report the cell identities, cell indices, PCI(s) and/or additional PCI indices associated with the neighboring cells and/or candidate target cells whose measured RSRP values are larger than and/or equal to the RSRP threshold value, to the source gNB/cells and/or one or more candidate target cells.

In some implementations, the report configuration may include an RSRQ threshold value. The UE may measure the RSRQ value(s) of the reference resources associated with the neighboring cells and/or the candidate target cells. After the L1 measurement, the UE may report which neighboring cells and/or candidate target cells have a better channel condition (e.g., the measured RSRQ is larger than and/or equal to the RSRQ threshold) to the source gNB/cells and/or one or more candidate target cells. For example, the UE may report the cell identities, cell indices, PCI(s) and/or additional PCI indices associated with the neighboring cells and/or candidate target cells whose measured RSRQ values are larger than and/or equal to the RSRQ threshold value to the source gNB/cells and/or one or more candidate target cells.

In some implementations, a UE may report a neighboring cell and/or a candidate target cell having better channel condition (e.g., the measured RSRP value is larger than and/or equal to the RSRP threshold value or the measured RSRQ is larger than and/or equal to the RSRQ threshold value) to the source gNB/cells and/or one or more candidate target cells. In a case that there are multiple neighboring cells and/or candidate target cells having a better channel condition (e.g., the measured RSRP value is larger than and/or equal to the RSRP threshold value or the measured RSRQ value is larger than and/or equal to the RSRQ threshold value), the UE may report a neighboring cell and/or a candidate target cell having the largest RSRP/RSRQ value, or the UE may report any one of the neighboring cells and/or the candidate target cells having a better channel condition to the source gNB/cells and/or one or more candidate target cells.

In some implementations, a UE may report multiple neighboring cells and/or candidate target cells having a better channel condition (e.g., the measured RSRP value is larger than and/or equal to the RSRP threshold value or the measured RSRQ value is larger than and/or equal to the RSRQ threshold value) to the source gNB/cells and/or one or more candidate target cells. In a case that multiple neighboring cells and/or candidate target cells have a better channel condition (e.g., the measured RSRP value is larger than and/or equal to the RSRP threshold value or the measured RSRQ value is larger than and/or equal to the RSRQ threshold value), the UE may report all of the neighboring cells and/or the candidate target cells to the source gNB/cells and/or one or more candidate target cells.

In some implementations, a UE may report multiple neighboring cells and/or candidate target cells having a better channel condition (e.g., the measured RSRP value is larger than and/or equal to the RSRP threshold value or the measured RSRQ value is larger than and/or equal to the RSRQ threshold value) to the source gNB/cells and/or one or more candidate target cells. In a case that (only) one neighboring cell and/or candidate target cell having a better channel condition (e.g., the measured RSRP value is larger than and/or equal to the RSRP threshold value or the measured RSRQ value is larger than and/or equal to the RSRQ threshold value), the UE may report the (only) one neighboring cell and/or candidate target cell to the source gNB/cells and/or one or more candidate target cells, or the UE may switch to perform a L3 HO (e.g., a CHO or a DAPS).

In some implementations, a UE may report multiple neighboring cells and/or candidate target cells having a better channel condition (e.g., the measured RSRP value is larger than and/or equal to the RSRP threshold value or the measured RSRQ value is larger than and/or equal to the RSRQ threshold value) to the source gNB/cells and/or one or more candidate target cells. The maximum number of the neighboring cells (N1) and/or the candidate target cells (N2) having a better channel condition that the UE is allowed to report may be configured by the source gNB/cell via RRC signaling. For example, the UE may report to the source gNB/cell (1) the information (e.g., identities/indices) associated with the neighboring cells with the top-N1 RSRP values larger than or equal to the RSRP threshold value, (2) the information (e.g., identities/indices) associated with the candidate target cells with the top-N2 RSRP values larger than or equal to the RSRP threshold value, and/or (3) the information (e.g., identities/indices) associated with the neighboring cells and/or the candidate target cells with the top-(N1+N2) RSRP values larger than or equal to the RSRP threshold value. For example, the UE may report to the source gNB/cell (1) the information (e.g., identities/indices) associated with the neighboring cells with the top-N1 RSRQ values larger than or equal to the RSRQ threshold value, (2) the information (e.g., identities/indices) associated with the candidate target cells with the top-N2 RSRQ values larger than or equal to the RSRQ threshold value, and/or (3) the information (e.g., identities/indices) associated with the neighboring cells and/or the candidate target cells with the top-(N1+N2) RSRQ values larger than or equal to the RSRQ threshold value.

In some implementations, in a case that there are no neighboring cells and/or candidate target cells with better channel condition (e.g., the measured RSRP value is larger than the RSRP threshold value or the measured RSRQ value is larger than the RSRQ threshold value), the UE may take one of two actions. First, the UE may initiate the L3 HO procedure, such as the CHO or DAPS procedure. Alternatively, the UE may send a request to the source gNB/cells. The request may be in various forms, such as an RRC message, a MAC CE, UCI, or an indication from the UE's upper layer (e.g., the RRC layer) to its lower layer (e.g., the MAC layer). In response to receiving the request, the source gNB/cells may prepare additional candidate target cells, generate an RRC message (e.g., RRC Reconfiguration message) and/or a particular IE (e.g., CellGroupConfig 1E, LTM-specific IE) including the information/configuration associated with the additional candidate target cells, and/or transmit the generated RRC message and/or the particular IE to the UE.

In some implementations, the L1 measurement results may include, but are not limited to, (1) the RSRP values of the reference resources which are covered by the active BWPs of the SpCell and the SCells, and/or (2) the RSRP values of the reference resources which are not covered by any of the active BWPs of the SpCell and the SCells.

In some implementations, the L1 measurement results may include, but are not limited to, (1) the RSRQ values of the reference resources which are covered by the active BWPs of the SpCell and the SCells, and/or (2) the RSRQ values of the reference resources which are not covered by any of the active BWPs of the SpCell and the SCells.

In some implementations, the L1 measurement results may include, but are not limited to, (1) the SINR values which are provided for the active BWPs of the SpCell and the SCells, and/or (2) the SINR values which are not provided for any of the active BWPs of the SpCell and the SCells.

In some implementations, the L1 measurement results may include, but are not limited to, (1) the RSRP values of the reference resources which are covered by the configured BWPs of the SpCell and the SCells, and/or (2) the RSRP values of the reference resources which are not covered by any of the configured BWPs of the SpCell and the SCells.

In some implementations, the L1 measurement results may include, but are not limited to, (1) the RSRQ values of the reference resources which are covered by the configured BWPs of the SpCell and the SCells, and/or (2) the RSRQ values of the reference resources which are not covered by any of the configured BWPs of the SpCell and the SCells.

In some implementations, the L1 measurement results may include, but are not limited to, (1) the SINR values which are provided for the configured BWPs of the SpCell and the SCells, and/or (2) the SINR values which are not provided for any of the configured BWPs of the SpCell and the SCells.

### DL Synchronization

The UE may perform DL synchronization to the selected target cell or to the candidate target cells during the LTM procedure. The UE may perform the DL synchronization after a cell switch (event) to the selected target cell in order to acquire the DL time and/or frequency synchronization, the DL system information and the DL data from the selected target cell. In some implementations, the UE may perform the DL synchronization after a cell switch to the selected target cell and after one or more subsequent cell switches to the selected target cells. However, in some implementations, the UE may perform the DL synchronization before a cell switch to the candidate target cells in order to reduce the interruption time, but at the sacrifice of complexity and overhead. It is noted that in one cell switch, the UE may switch to a target cell. In some implementations, the UE may perform DL synchronization before receiving a cell switch command. The terms “cell switch command,” “LTM cell switch command MAC CE,” “cell switch command (or MAC CE)” and may be used interchangeably in the present disclosure.

The UE may receive and/or be configured with the information required for DL synchronization to the selected target cell or to the candidate target cells from the source gNB/cell via RRC signaling and/or lower layer signaling (e.g., L1 signaling, L2 signaling). For example, the UE may receive an RRC message including the information required for DL synchronization during the RRC pre-configuration from the source gNB/cell. For example, the UE may receive the MAC CE (or cell switch command) including the information required for DL synchronization from the source gNB/cell. For example, the UE may receive DCI including the information required for DL synchronization. The information required for DL synchronization may include, but is not limited to, at least one of the following: IDs or indices of the candidate target cells, the ID or index of the selected target cell, the indices of RSs (e.g., SSB) associated with the candidate target cells, the indices of the resource blocks associated with the selected target cell, the time/frequency information associated with the candidate target cells, the time/frequency information associated with the selected target cell, and the TCI state ID associated with the candidate target cells or the selected target cell. The cell switch command may include a MAC CE that includes the required information (e.g., beam information, PCI, DL/UL synchronization information corresponding to the selected candidate target cell) for the UE to switch to the selected target cell. The selected target cell may be one of the candidate target cells that the source gNB/cell indicates to a UE to perform the cell switch.

### UL Synchronization

The UE may perform UL synchronization, e.g., including TA acquisition, to the selected target cell or to the candidate target cells during the LTM procedure. The UE may perform the UL synchronization after the DL synchronization completes. In some implementations, the UE may perform the DL synchronization and the UL synchronization to the selected target cell after a cell switch. In some implementations, to reduce the interruption time, the UE may perform the DL synchronization and the UL synchronization to the candidate target cells before the cell switch at the sacrifice of overhead and complexity. In some implementations, the UE may perform the DL synchronization before the cell switch and perform the UL synchronization after the cell switch.

During the UL synchronization step, the UE may perform an RA procedure (e.g., a contention-based RA procedure, a contention-free RA procedure, a 2-step RA procedure, or a 4-step RA procedure) with the selected target cell or with the candidate target cells in order to (1) acquire the UL timing and/or TA information and/or (2) transmit UL data to the selected target cell or to the candidate target cells. In some implementations, during the UL synchronization, the UE may perform a RACH-less procedure, e.g., without performing an RA procedure, with the selected target cell or with the candidate target cells in order to (1) acquire the UL timing and/or TA information and/or (2) transmit UL data to the selected target cell or to the candidate target cells.

The UE may receive the information required for UL synchronization via RRC signaling or lower layer signaling (e.g., MAC CE or DCI) from the source gNB/cell. Upon receiving the information required for UL synchronization, the UE may configure the information. For example, during the RRC pre-configuration step, the UE may receive an RRC message including the information required for UL synchronization from the source gNB/cell. The UE may receive a MAC CE including the information required for UL synchronization from the source gNB/cell. The information required for the UL synchronization may include, but is not limited to, at least one of the following: the PRACH resource configuration associated with the selected target cell, the PRACH resource configurations associated with the candidate target cells, the preamble sequence configuration associated with the selected target cell, the preamble sequence configurations associated with the candidate target cells, the indication of performing a RACH-less procedure, the indication of performing an RA procedure (e.g., a contention-free RA procedure, a contention-based RA procedure), the indication of indicating to perform 2-step RACH or 4-step RACH, the TAG index associated with the selected target cell, the TAG indices associated with the candidate target cells, the UL carrier types (e.g., NUL, SUL) associated with the selected target cell (e.g., the UE may perform the indicated RA procedure on the UL carrier indicated by the UL carrier types associated with the selected target cell), the UL carrier types associated with the candidate target cells (e.g., the UE may perform the indicated RA procedure on the UL carrier indicated by the UL carrier types associated with the candidate target cells), the SRS configuration associated with the selected target cell, and SRS configurations associated with the candidate target cells.

### Cell Switch

During the LTM procedure, the source gNB/cell may change the UE's serving cell(s) (e.g., UE's PCell, UE's SCells, UE's PSCell) via MAC CE signaling. The source gNB/cell may determine (or select) a target cell among candidate target cells and then transmit a cell switch command (e.g., a MAC CE) to the UE. The cell switch command may include the required information for the UE to switch to the selected target cell. The source gNB/cell may determine (or select) the target cell based on factors including, but not limited to, at least one of the following: the candidate target cell configurations provided to the UE during the RRC pre-configuration, the received L1 measurement reports from the UE, the network topology, and the resource availability.

The cell switch command (e.g., a MAC CE, DCI) may include, but is not limited to, at least one of the following: the index (e.g., the PCI value, the addition PCI index, the serving cell index) of the selected target cell, the (unified) TCI state (e.g., the joint TCI state, the DL TCI state, the UL TCI state) associated with the selected target cell, the TA information (e.g., the TAG ID, the TA value) associated with the selected target cell, the index of the candidate target cell configuration associated with the selected target cell, the index of the BWP (e.g., the initial BWP, the DL BWP, the UL BWP, the BWP the UE may switch to) associated with the selected target cell, the cell type to be switched (e.g., the PCell, the SCell, the PSCell), the index of MAC CE as a cell switch command for the RRC pre-configuration, the total number of cell switches (or “cell switch events”) per the RRC pre-configuration, a dedicated DCI format that informs the cell switch, and a DCI field including information for the cell switch. In some implementations, the index of the MAC CE as a cell switch command for the RRC pre-configuration and the total number of cell switches per the RRC pre-configuration may be useful for a subsequent cell switch in a (subsequent) LTM procedure.

Upon the UE receives the cell switch command (e.g., a MAC CE) from the source gNB/cell, the UE may perform, based on the information in the cell switch command, a cell switch to the target cell indicated by the cell switch command. Depending on the content of the cell switch command, the cell switch may refer to a PCell change (e.g., switch the source PCell to a target PCell), an SCell change (e.g., switch the source SCell to a target SCell), and/or a PSCell change (e.g., switch the source PSCell to a target PSCell).

In some implementations, if the UE retains the stored candidate target cell configurations after performing the cell switch and later receives another cell switch command (e.g., a MAC CE), then the UE may perform a subsequent cell switch. That is, a subsequent LTM procedure between the candidate target cells may be performed by the UE and the gNB/cell without a new RRC (pre) configuration after the first cell switch and before the subsequent cell switches. That is, the RRC pre-configuration for the first cell switch may be applied (or used) by the UE for the subsequent cell switches. In some implementations, the total number of cell switches per RRC (pre) configuration may be configured by the network or pre-defined. For example, the UE may receive the information of the total number of cell switches per RRC (pre) configuration in the RRC message received during the RRC pre-configuration step or in the cell switch command (especially for the first cell switch after the RRC pre-configuration step).

In some implementations, once the UE receives the information of the total number of cell switches per RRC (pre) configuration, the UE may perform a subsequent cell switch. The information of the total number of cell switches per RRC (pre) configuration may indicate that the UE is allowed to perform the subsequent cell switch. In some implementations, the first cell switch may not be counted for the total number of cell switches per RRC (pre) configuration. In some implementations, the first cell switch may be counted for the total number of cell switches per RRC (pre) configuration. If the number of cell switches that the UE performs per RRC (pre) configuration exceeds the configured/pre-defined total number of cell switches per RRC (pre) configuration, the UE may receive an RRC message for RRC (pre) configuration from the source gNB/cell, release the stored candidate target cell configurations, and/or ignore the received cell switch command. The UE may be configured with a specific number of cell switches per RRC (pre) configuration. The configured number of cell switches may be received from the source gNB/cell through various means, such as via RRC signaling (e.g., in an RRC message during the RRC pre-configuration step) and/or via lower layer signaling (e.g., in the MAC CE of a cell switch command). In some implementations, the number of cell switches per RRC (pre) configuration may be pre-defined in the 3GPP standard (e.g., a fixed positive value).

In some implementations, once the UE completes the cell switch to the target cell, the UE may transmit an indicator to the selected target cell (e.g., HARQ-ACK information, or ACK) to indicate the successful completion of the LTM cell switch towards the selected target cell. The indicator may be included in an RRC message transmitted by the UE to the selected target cell. The indicator may be included in lower layer signaling, e.g., UCI, HARQ ACK/NACK, transmitted by the UE to the selected target cell.

In some implementations, once the UE completes the cell switch to the selected target cell, the UE may transmit an indicator to the source gNB/cell to indicate the successful completion of the LTM cell switch towards the selected target cell. The indicator may be included in an RRC message transmitted by the UE to the source gNB/cell. The indicator may be included in a lower layer signaling, e.g., UCI, HARQ ACK/NACK, transmitted by the UE to the source gNB/cell. For example, the UE may transmit an ACK once the UE successfully completes the cell switch to the target cell. The UE may transmit the HARQ-ACK information (e.g., ACK or NACK) in UCI via a PUCCH or a PUCCH multiplexed with a PUSCH to the source gNB/cell. In some implementations, an indicator may be used to indicate whether the UE has successfully completed a cell switch to the target cell. This indicator may be a bit with a value of ‘1’ or ‘0’. In some implementations, a value of ‘1’ of the indicator may indicate the successful completion of the cell switch. In some implementations, a value of ‘0’ of the indicator may indicate the successful completion of the cell switch.

In some implementations, once the UE determines that the cell switch to the target cell fails, the UE may transmit an indicator (e.g., HARQ-ACK information, or NACK) to the source gNB/cell to indicate the unsuccessful completion of the LTM cell switch towards the selected target cell. The indicator may be included in an RRC message transmitted by the UE to the source gNB/cell. The indicator may be included in lower layer signaling, e.g., UCI, HARQ ACK/NACK, transmitted by the UE to the source gNB/cell. For example, the UE may transmit NACK once the UE fails to complete the cell switch to the target cell. The UE may transmit UCI that includes the HARQ-ACK information in either a PUCCH or a PUCCH multiplexed with a PUSCH to the source gNB/cell. In some implementations, an indicator may be used to indicate whether the UE has fails to complete a cell switch to the target cell. This indicator may be a bit with a value of ‘1’ or ‘0’. In some implementations, a value of ‘1’ of the indicator may indicate the unsuccessful completion (or failure) of the cell switch. In some implementations, a value of ‘0’ of the indicator may indicate the unsuccessful completion (or failure) of the cell switch.

In some implementations, a UE may transmit an indicator (a success indicator or an unsuccess indicator) to the selected target cell or the source gNB/cell to indicate whether the LTM cell switch towards the selected target cell is successful or not. The UE may transmit a success indicator (e.g., HARQ-ACK information, an ACK, a MAC CE including one or more field(s) used to indicate that the LTM cell switch is successful) to the selected target cell to indicate the successful completion of the LTM cell switch towards the selected target cell. The UE may transmit an unsuccess indicator (e.g., HARQ-ACK information, NACK, a MAC CE including one or more field(s) used to indicate that the LTM cell switch is unsuccessful, a MAC CE including one or more field(s) indicating the UE to fallback to an L3 HO) to the source gNB/cell to indicate the unsuccessful completion of the LTM cell switch towards the selected target cell.

### Scenarios

An LTM procedure may support several scenarios, including: (1) intra-gNB-DU mobility (also known as intra-CU intra-DU), (2) inter-gNB-DU mobility (also known as intra-CU inter-DU), (3) inter-frequency mobility, (4) PCell change in a non-CA scenario, (5) PCell change without SCell change in a CA scenario, (6) PCell change with SCell changes in a CA scenario, and (7) DC scenario (e.g., at least for the PSCell change without MN involvement case, e.g., intra-SN). The abovementioned scenario (6) may include the following three cases: a. the target PCell/target SCell(s) is not a current serving cell (CA-to-CA scenario with PCell change), b. the target PCell is a current SCell, and c. the target SCell is the current PCell.

For intra-gNB-DU mobility, the UE may switch from the source cell to the selected target cell. In such a case, the source cell and the selected target cell may belong to the same CU and the same DU within a gNB. The UE may apply the same PHY layer of the UE to the source cell and to the selected target cell. The UE may apply the same MAC layer of the UE to the source cell and to the selected target cell. The UE may apply the same RLC layer of the UE to the source cell and to the selected target cell. The UE may apply the same PDCP layer of the UE to the source cell and to the selected target cell. The UE may apply the same RRC layer of the UE to the source cell and to the selected target cell.

### Failure Determination

L1/L2 mobility enhancement may involve the RRC pre-configuration of the information associated with the candidate target cells, the L1 measurement and reporting, the DL synchronization with the (candidate) target cell(s), the UL synchronization with the (candidate) target cell(s), the cell switch to the selected target cell, and/or the subsequent cell switch to selected target cells. However, the L1/L2 mobility enhancement may fail. For example, a UE may fail to successfully switch to the selected target cell when performing the LTM procedure. The UE may determine that the L1/L2 mobility enhancement fails based on one or more parameters (e.g., timers, indicators, counters, time windows) and/or one or more configurations in one or more steps of the LTM procedure (e.g., the RRC pre-configuration, the L1 measurement and reporting, the DL synchronization, the UL synchronization, cell switch, and the subsequent switch).

In some implementations, in a case that the UE fails to successfully decode the received RRC message (e.g., the RRC reconfiguration message) during the RRC pre-configuration step in the L1/L2 mobility enhancement, the UE may determine that the RRC pre-configuration step fails (e.g., reconfiguration failure). For example, during the RRC pre-configuration step, the UE may be unable to successfully decode the ASN.1 format of the received RRC message. Once the UE determines that the RRC pre-configuration step fails, the UE may further determine that the L1/L2 mobility enhancement fails.

In some implementations, in a case that the UE determines that the received RRC message (e.g., RRC reconfiguration message) during RRC pre-configuration step fails to pass the validity and/or the compliance check, the UE may determine that the RRC pre-configuration step fails (e.g., reconfiguration failure). Once the UE determines that the RRC pre-configuration step fails, the UE may further determine that the L1/L2 mobility enhancement fails.

In some implementations, in a case that the UE is unable to comply with at least part of the configuration included in the RRC message (e.g., the RRC reconfiguration message) during RRC pre-configuration step in the L1/L2 mobility enhancement, the UE may determine that the RRC pre-configuration step fails (e.g., reconfiguration failure). Once the UE determines that the RRC pre-configuration step fails, the UE may further determine that the L1/L2 mobility enhancement fails.

In some implementations, when a timer associated with the RRC pre-configuration step expires, the UE may determine that the RRC pre-configuration step fails. In some implementations, if the UE determines that the RRC pre-configuration step fails, the UE may transmit a request to the source gNB/cell to request an RRC pre-configuration that includes the information/configuration associated with the candidate target cells. The request may be transmitted via an RRC message, L2 signaling, or L1 signaling. For example, in a case that the UE determines that the RRC pre-configuration step fails, the UE may transmit a MAC CE or a HARQ ACK/NACK to the source gNB/cell to request an RRC message from the source gNB/cell in the RRC pre-configuration step.

In some implementations, in a case that the UE determines that the RRC pre-configuration step fails, the UE may switch to an L3 HO (e.g., a CHO, a DAPS, or a legacy HO). In some implementations, when the timer associated with the RRC pre-configuration step expires, the UE may send an indicator to the source serving cell/gNB. The indicator may inform or indicate that the LTM procedure was not completed successfully (or “unsuccessful completion of LTM”). In some implementations, the indicator may include at least one of the following: HARQ-ACK information, NACK, a MAC CE including one or more field(s) indicating that the pre-configuration step is unsuccessful, and a MAC CE including one or more field(s) indicating the UE to fallback to an L3 HO.

In some implementations, after the UE indicates the unsuccessful completion of LTM, the UE may fall back to perform the L3 HO. For example, the UE may receive the RRC reconfiguration message associated with a legacy HO, a CHO or a DAPS. In some implementations, upon the UE determines that the RRC pre-configuration step fails, the UE may further determine that the L1/L2 mobility enhancement fails. The UE may receive a timer value for the timer associated with the RRC pre-configuration step via an RRC message (e.g., an RRC reconfiguration message or an RRC message in the RRC pre-configuration step) or via a MAC CE from the serving cell/gNB.

In some implementations, the UE may set the timer associated with the RRC pre-configuration step with a timer value associated with the timer when one or more of the following conditions occur: (1) the UE receives the RRC message during RRC pre-configuration step, (2) the UE receives the timer value, (3) the L1/L2 mobility enhancement is triggered, and (4) the RRC pre-configuration step is triggered or begins.

In some implementations, the UE may (re) start the timer associated with the RRC pre-configuration when one or more of the following conditions occur: (1) the UE receives the RRC message for RRC pre-configuration and (2) the UE sets the timer associated with the RRC pre-configuration step with the timer value associated with the timer. The UE may stop the timer associated with the RRC pre-configuration when one or more of the following conditions occur: (1) the RRC pre-configuration step completes, (2) the UE determines that the L1/L2 mobility enhancement fails, (3) the UE falls back to the L3 HO (e.g., a CHO, a DAPS, or legacy HO), and (4) the UE receives the RRC reconfiguration message for the L3 HO.

In some implementations, there are circumstances where a UE may not successfully receive the configuration for the L1 measurement and reporting. These circumstances may include scenarios such as: (1) the UE being unable to decode the L1 measurement configuration successfully, (2) the UE being unable to comply with (part of) the L1 measurement configuration, and (3) the L1 measurement configuration failing to pass the validity and/or compliance check. Additionally, there are circumstances where the UE may not successfully transmit the L1 measurement reports to the source gNB/cell. These circumstances include: (1) the source gNB/cell not successfully receiving the L1 measurement report, (2) the UE not receiving the HARQ ACK/NACK for the transmission of the L1 measurement reports to the source gNB/cell within a specific time period, and (3) the UE receiving the HARQ NACK for the transmission of L1 measurement reports to the source gNB/cell. In any of these circumstances, the UE may determine that the L1 measurement and reporting step fails.

In some implementations, there are circumstances where a UE may not successfully transmit the L1 measurement reports to the source gNB/cell. These circumstances may include: (1) the UE not receiving the HARQ ACK/NACK for the L1 measurement report within a set timer period, and (2) the UE receiving the HARQ NACK for the transmission of L1 measurement reports to the source gNB/cell. In these circumstances, the UE may retransmit the L1 measurement reports to the source gNB/cell. In some implementations, if the UE fails to transmit the L1 measurement report to the source gNB/cell successfully, the UE may request UL resources (e.g., an UL grant and/or a scheduling request) from the source gNB/cell, so as to retransmit the L1 measurement reports to the source gNB/cell.

In some implementations, a UE may be (pre) configured with a counter value corresponding to the number of times the UE fails to successfully transmit the L1 measurement report to the source gNB/cell (e.g., the number of times that the UE receives HARQ NACK in response to the transmission of the L1 measurement report, or the number of times that the UE does not receive the HARQ ACK/NACK corresponding to the L1 measurement report within a timer period). If the UE fails to transmit the L1 measurement report successfully (e.g., if the source gNB/cell does not receive the L1 measurement report successfully, or the UE receives a HARQ NACK in response to the transmission of the L1 measurement report, or the UE does not receive the HARQ ACK/NACK corresponding to the L1 measurement report within a timer period), the UE may increase the value of a counter by one. Once the value of the counter reaches the counter value, the UE may determine that the L1 measurement and reporting step fails.

In some implementations, if the UE determines that the L1 measurement and reporting step fails, the UE may also determine that the L1/L2 mobility enhancement fails. In some implementations, the failure of the L1/L2 mobility enhancement may lead the UE to switch to an L3 HO procedure (e.g., a CHO, a DAPS, or a legacy HO). For example, the UE may then receive an RRC reconfiguration message for a legacy HO, CHO, or DAPS. In some implementations, the UE may reset the counter when one or more of the following conditions are met: (1) the UE successfully transmits the L1 measurement reports (e.g., the UE receives HARQ ACK in response to the transmission of L1 measurement reports within a time period), (2) the UE determines that the L1/L2 mobility enhancement fails, (3) the UE switches to the L3 HO procedure, (4) the UE determines that L1 measurement and reporting step fails, and (5) the UE transmits an indicator or a scheduling request to inform the failure of the L1 measurement and reporting step or to request a resource.

In some implementations, when a timer associated with the L1 measurement and reporting expires, the UE may determine that the L1 measurement and reporting fails. In some implementations, if the UE determines that the L1 measurement and reporting step fails, the UE may transmit a request to the source gNB/cell to request information including the L1 measurement and reporting information/configuration associated with the candidate target cells. In some implementations, if the UE determines that the L1 measurement and reporting step fails, the UE may switch to an L3 HO procedure (e.g., a CHO, a DAPS, or a legacy HO). In some implementations, after the UE indicates the failure of the L1 measurement and reporting step to the source gNB/cell, the UE may receive an RRC reconfiguration message for a legacy HO, a CHO or a DAPS. In some implementations, when the timer associated with the L1 measurement and reporting step expires, the UE may transmit an indicator (e.g., HARQ-ACK information, NACK, a MAC CE including one or more field(s) indicating that the L1 measurement and reporting step is unsuccessful, a MAC CE including one or more field(s) indicating the UE to fallback to an L3 HO) to indicate the unsuccessful completion of LTM to the source serving cell/gNB. In some implementations, after the UE transmits the indicator, the UE may receive an RRC reconfiguration for a legacy HO, a CHO, or a DAPS from the source gNB/cell.

In some implementations, when the UE determines that the L1 measurement and reporting step fails, the UE may further determine that the L1/L2 mobility enhancement fails. It is noted that the UE may receive a timer value for the timer associated with the L1 measurement and reporting step via an RRC message, a MAC CE from the serving cell/gNB, or DCI from the serving cell/gNB. The RRC message may be an RRC message received in the RRC pre-configuration step, an RRC reconfiguration message, an RRC message in the measurement configuration, or an RRC message in the report configuration.

The UE may set the timer associated with the L1 measurement and reporting step with the timer value associated with the timer when one or more of the following conditions occur: (1) the UE receives the timer value, (2) the UE receives the timer value during RRC pre-configuration step, (3) the UE completes the RRC pre-configuration successfully, (4) the UE completes L1 measurement and reporting successfully, (5) the L1/L2 mobility enhancement is triggered, and (6) the UE receives the measurement configuration associated with the serving cell or the target cell(s) and/or report configuration associated with the serving cell or the target cell(s) from the serving cell/gNB.

The UE may (re) start the timer associated with the L1 measurement and reporting step with the timer value associated with the timer when one or more of the following conditions occur: (1) the UE sets the timer associated with the L1 measurement and reporting step, (2) the UE receives the timer value, (3) the UE receives the measurement configuration associated with the serving cell or the target cell(s) and/or report configuration associated with the serving cell or the target cell(s) from the serving cell/gNB, (4) the UE completes the RRC pre-configuration successfully, (5) the UE completes L1 measurement and reporting successfully, and (6) the L1/L2 mobility enhancement is triggered.

The UE may stop the timer associated with the L1 measurement and reporting step when one or more of the following conditions occur: (1) the L1 measurement and reporting step completes successfully, (2) the UE determines that the L1/L2 mobility enhancement fails, (3) the UE receives the measurement configuration and/or report configuration, (4) the UE falls back to an L3 HO (e.g., a CHO, a DAPS, or a legacy HO), (5) the UE receives the RRC reconfiguration message for an L3 HO, and (6) the UE transmits an indicator or a scheduling request to inform the failure of L1 measurement and reporting step or to request a resource.

In some implementations, in a case that the UE fails to receive the DL RSs from the (candidate) target cells (e.g., the RSRP of the DL RSs from the (candidate) target cells is below a threshold, and/or the RSRQ of the DL RSs from the (candidate) target cells is below a threshold), the UE may determine that the DL synchronization fails. In some implementations, the UE may receive the DL RSs of the candidate target cells based on the RRC pre-configuration and/or the L1 measurement and report configuration configured by the source gNB/cell. If the UE fails to receive the DL RSs of all candidate target cells successfully (in a configured period configured by the source gNB/cell), the UE may determine that the DL synchronization fails. In some implementations, the UE may receive the DL RSs of the selected target cell(s) indicated by the source gNB/cell. If the UE fails to receive the DL RSs of the selected target cell(s) successfully (in a configured period configured by the source gNB/cell), the UE may determine that the DL synchronization fails. In some implementations, in a case that the UE fails to receive the DL RSs from the configured BWP(s) or the active BWP(s) (e.g., the RSRP of the DL RSs from the configured BWP or the active BWP is below a threshold, the RSRQ of the DL RSs from the configured BWP or the active BWP is below a threshold), the UE may determine that the DL synchronization fails. In some implementations, there are cases where the UE may fail to receive the DL RSs from a particular BWP that is different from the configured or active BWP(s). This failure may occur, for example, if the RSRP or the RSRQ of the DL RSs from the particular BWP is below a threshold. In the cases where the UE fails to receive the DL RSs from the particular BWP, the UE may determine that DL synchronization fails.

In some implementations, in a case that the UE determines that the DL synchronization step fails, the UE may further determine that the L1/L2 mobility enhancement fails.

In some implementations, in a case that a UE fails to receive the DL RSs of candidate target cells or selected target cell(s) successfully in a configured period, the UE may determine that the DL synchronization fails. The configured period may be configured by the source gNB/cell. The configured period may be the periodicity of the DL RSs of the candidate target cells or the selected target cell(s).

In some implementations, when a timer associated with DL synchronization expires, the UE may determine that the DL synchronization fails. In some implementations, when the timer associated with the DL synchronization step expires, the UE may transmit an indicator (e.g., HARQ-ACK information, NACK, a MAC CE including one or more field(s) used to indicate that the DL synchronization step is unsuccessful, or a MAC CE including one or more field(s) used to indicate to fallback to an L3 HO) to indicate the unsuccessful completion of LTM to the source serving cell/gNB. The UE may receive a timer value for the timer associated with the DL synchronization step via an RRC message (e.g., an RRC message received in the RRC pre-configuration step or an RRC reconfiguration message) or via a MAC CE from the serving cell/gNB or via DCI from the serving cell/gNB.

The UE may set the timer associated with the DL synchronization step with the timer value associated with the timer when one or more of the following conditions occur: (1) the UE receives the timer value, (2) the UE receives the timer value during RRC pre-configuration step, (3) the UE completes the RRC pre-configuration successfully, (4) the UE completes L1 measurement and reporting successfully, (5) the L1/L2 mobility enhancement is triggered, (6) the UE selects the target cell/gNB, and (7) the UE starts the DL synchronization with the (candidate) target cell(s).

The UE may (re) start the timer associated with the DL synchronization step with the timer value associated with the timer when one or more of the following conditions occur: (1) the UE sets the timer associated with the DL synchronization step, (2) the UE receives the timer value, (3) the UE receives the measurement configuration and/or report configuration from the serving cell/gNB, (4) the UE completes the RRC pre-configuration successfully, (5) the UE completes L1 measurement and reporting successfully, (6) the L1/L2 mobility enhancement is triggered, (7) the UE receives the cell switch command including the target cell, and (8) when the UE starts to perform DL synchronization with the target cell.

The UE may stop the timer associated with the DL synchronization step when one or more of the following conditions occur: (1) the DL synchronization step completes successfully, (2) the UE determines that the L1/L2 mobility enhancement fails, (3) the UE receives the information of new target cells, (4) the UE falls back to an L3 HO (e.g., a CHO, a DAPS, or a legacy HO), (5) the UE receives the RRC reconfiguration message for an L3 HO, and (6) the UE transmits an indicator or a scheduling request to inform the failure of DL synchronization step or to request a resource.

In some implementations, when the UE fails to receive the TA information associated with the (candidate) target cells (e.g., the RA procedure fails, the UE fails to receive the RAR in an RA procedure for UL synchronization), and the UE may further determine that the UL synchronization fails. In some implementations, a UE may transmit a preamble to each candidate target cell, where the preamble index of the preamble transmitted to different candidate target cells may be the same or different. The UE may receive an RAR including the TA information associated with different candidate target cells or TAG IDs associated with different candidate target cells from the source gNB/cell. If the UE fails to receive the RAR from the source gNB/cell, the UE may determine that the UL synchronization fails.

In some implementations, a UE may transmit a preamble to each candidate target cell, where the preamble index of the preamble transmitted to different candidate target cells may be the same or different. The UE may receive an RAR including the TA information associated a candidate target cell or the TAG ID associated with one or more than one candidate target cells. The UE may receive the RAR from one or more of the candidate target cells. If the UE fails to receive the RAR from all of the candidate target cells or any one of the candidate target cells, the UE may determine that the UL synchronization fails. In some implementations, the UE may transmit a preamble to the selected target cell. The UE may receive an RAR or a cell switch command including the TA information associated with the selected target cell or TAG IDs associated with the selected target cells from the source gNB/cell or the selected target cell. If the UE fails to receive the RAR or the cell switch command from the source gNB/cell, the UE may determine that the UL synchronization fails.

In some implementations, once the UE determines that the UL synchronization step fails, the UE may further determine that the L1/L2 mobility enhancement fails.

In some implementations, when a timer associated with UL synchronization expires, the UE may determine that the UL synchronization fails. In some implementations, when the timer associated with the UL synchronization step expires, the UE may transmit an indicator (e.g., HARQ-ACK information, NACK, a MAC CE including one or more field(s) indicating that the UL synchronization step is unsuccessful, a MAC CE including one or more field(s) indicating the UE to fallback to an L3 HO) to indicate the unsuccessful completion of LTM to the source serving cell/gNB. The UE may receive a timer value for the timer associated with the UL synchronization step via an RRC message (e.g., an RRC message received in the RRC pre-configuration step, an RRC reconfiguration message) or via a MAC CE from the serving cell/gNB or via a DCI from the serving cell/gNB.

The UE may set the timer associated with the UL synchronization step with the timer value associated with the timer when one or more of the following conditions occur: (1) the UE receives the timer value, (2) the UE receives the timer value during RRC pre-configuration step, (3) the UE completes the RRC pre-configuration successfully, (4) the UE completes L1 measurement and reporting successfully, (5) the L1/L2 mobility enhancement is triggered, (6) the UE selects the target cell/gNB, and (7) the UE starts the UL synchronization with the (candidate) target cell(s).

The UE may (re) start the timer associated with the UL synchronization step with the timer value associated with the timer when one or more of the following conditions occur: (1) the UE sets the timer associated with the UL synchronization step, (2) the UE receives the timer value, (3) the UE completes the RRC pre-configuration successfully, (4) the UE completes the DL synchronization successfully, (5) the UE completes L1 measurement and reporting successfully, (6) the L1/L2 mobility enhancement is triggered, (7) the UE receives the cell switch command including the target cell, and (8) the UE starts to perform UL synchronization with the target cell.

The UE may stop the timer associated with the UL synchronization step when one or more of the following conditions occur: (1) the UL synchronization step completes successfully, (2) the UE determines that the L1/L2 mobility enhancement fails, (3) the UE receives the information of new target cells, (4) the UE falls back to an L3 HO (e.g., a CHO, a DAPS, or a legacy HO), (5) the UE receives the RRC reconfiguration message for an L3 HO, and (6) the UE transmits an indicator or a scheduling request to inform the failure of UL synchronization step or to request a resource.

In some implementations, in a case that the UE fails to decode the cell switch command (or MAC CE) successfully, the UE may determine that the cell switch step fails. In some implementations, if a UE fails to receive or decode the cell switch command/MAC CE from the source gNB/cell successfully, the UE may request that the source gNB/cell retransmits the cell switch command (or MAC CE). In some implementations, if a UE receives a cell switch command (or MAC CE) successfully, the UE may transmit HARQ-ACK information (e.g., ACK) to the source gNB/cell or the selected target cell. If the UE fails to receive the confirmed information from the selected target cell, the UE may determine that the cell switch step or the L1/L2 mobility enhancement fails. It is noted that the confirmed information may be the information transmitted from the selected target cell to inform the UE that the L1/L2 cell switch is completed. The confirmed information may be L1 signaling or L2 signaling (e.g., HARQ ACK/NACK).

In some implementations, a UE may be configured with a counter value corresponding to the situation that the UE fails to successfully decode the cell switch command (or MAC CE). The counter value may be configured by the source gNB/cell to the UE via RRC signaling or may be predefined. If the UE fails to decode the received MAC CE (e.g., cell switch command) during cell switch step in the L1/L2 mobility enhancement or the UE fails to receive/decode/detect the DCI that schedules the PDSCH carrying the cell switch command within a time window, the UE may increase the value of a counter by one. When the value of the counter reaches the counter value, the UE may determine that the cell switch step fails.

In some implementations, once the UE determines that the cell switch step fails, the UE may further determine that the L1/L2 mobility enhancement fails. In some implementations, once the UE determines that the cell switch step fails or the UE indicates to the source gNB/cell that the cell switch step fails via L1 or L2 signaling (e.g., a MAC CE or a HARQ ACK/NACK), the UE may switch to the L3 HO (e.g., a CHO, a DAPS, or a legacy HO). In some implementations, after the UE indicates the failure of the cell switch step to the source gNB/cell, the UE may receive an RRC reconfiguration message for a legacy HO, a CHO or a DAPS.

In some implementations, the UE may reset the counter when one or more of the following conditions occur: (1) the UE successfully receives the cell switch command (or MAC CE), (2) the UE determines L1/L2 mobility enhancement fails, (3) the UE switches to the L3 HO procedure, (4) the UE determines that cell switch step fails, (5) the UE transmits an indicator or a scheduling request to inform the failure of cell switch step or to request a resource, and (6) the UE receives the RRC reconfiguration message including the information for an L3 HO.

In some implementations, in response to the transmission of the L1 measurement report(s) in the L1/L2 mobility enhancement, the UE may attempt to detect a DCI format with a CRC scrambled by an RNTI within a time window. The DCI may schedule the PDSCH carrying the cell switch command. The DCI format may be a DL DCI format (e.g., DCI format 1_0, DCI format 1_1). The RNTI may be a C-RNTI, an MCS-C-RNTI, a CS-RNTI, an RA-RNTI, and/or an L1/L2-mobility-specific RNTI. The UE may be configured with the L1/L2-mobility-specific RNTI by the source gNB/cell via RRC signaling. For example, the L1/L2-mobility-specific RNTI may be included in the RRC pre-configuration in L1/L2 mobility. In some implementations, the L1/L2-mobility-specific RNTI may be predefined. In addition, it is noted that the time window may start at the first symbol of the earliest CORESET that the UE is configured to receive the PDCCH for a search space set, where the earliest CORESET may start at least one symbol after the last symbol of the slot used to transmit the L1 measurement reports. That is, the time window may start after the last symbol of the slot used to transmit the L1 measurement reports. The search space set may be a CSS set (e.g., a Type-1 PDCCH CSS set or a Type-1A PDCCH CSS set), an USS set, and/or an L1/L2-mobility-specific search space set. The search space (set) may be configured via RRC signaling. The search space (set) configuration may be included in the RRC pre-configuration in L1/L2 mobility.

In some implementations, the UE may transmit an L1 indicator (e.g., HARQ ACK/NACK) or an L2 indicator to the source gNB/cell to request a cell switch transmission when one or more of the following conditions occur: (1) the UE fails to receive (or decode) the cell switch command (or MAC CE) successfully, (2) the UE fails to receive (or decode or detect) the DCI scheduling the PDSCH carrying the cell switch command within a time window, and (3) the UE fails to receive (or decode) the cell switch command (or MAC CE) successfully.

In some implementations, the UE may transmit a HARQ ACK indicator (e.g., NACK) corresponding to the cell switch command (or MAC CE) reception to the source gNB/cell to request a cell switch command retransmission. In some implementations, if the UE fails to receive (or decode or detect) the DCI that schedules the PDSCH carrying the cell switch command within a time window, the UE may retransmit the L1 measurement report(s) to the source gNB/cell to request a cell switch command (or MAC CE) retransmission.

In some implementations, when a timer associated with the cell switch step expires, the UE may determine that the cell switch step fails. In some implementations, when the timer associated with the cell switch step expires, the UE may transmit an indicator (e.g., HARQ-ACK information, a NACK, a MAC CE including one or more field(s) indicating that the cell switch step is unsuccessful, or a MAC CE including one or more field(s) indicating the UE to fallback to an L3 HO) to indicate the unsuccessful completion of LTM to the source serving cell/gNB. In some implementations, when the UE determines that the cell switch step fails, the UE may further determine that the L1/L2 mobility enhancement fails. It is noted that the UE may receive a timer value for the timer associated with the cell switch step via an RRC message (e.g., an RRC message received in the RRC pre-configuration step or an RRC reconfiguration message) or via a MAC CE from the serving cell/gNB.

The UE may set the timer associated with the cell switch step with the timer value associated with the timer when one or more of the following conditions occur: (1) the UE receives the timer value, (2) the UE receives the timer value during RRC pre-configuration step, (3) the UE completes the RRC pre-configuration successfully, (4) the UE completes L1 measurement and reporting successfully, (5) the UE completes DL synchronization (before the cell switch) successfully, (6) the UE completes UL synchronization (before the cell switch) successfully, (7) the cell switch is triggered or begins, (8) the L1/L2 mobility enhancement is triggered, and (9) the UE receives the cell switch command from the serving cell/gNB.

The UE may (re) start the timer associated with the cell switch step with the timer value associated with the timer when one or more of the following conditions occur: (1) the UE sets the timer associated with the cell switch step, (2) the UE receives the timer value, (3) the UE receives the cell switch command from the serving cell/gNB, (4) the UE completes the RRC pre-configuration successfully, (5) the UE completes L1 measurement and reporting successfully, (6) the UE completes DL synchronization (before the cell switch) successfully, (7) the UE completes UL synchronization (before the cell switch) successfully, (8) the cell switch is triggered or begins, and (9) the L1/L2 mobility enhancement is triggered.

The UE may stop the timer associated with the cell switch step when one or more of the following conditions occur: (1) the cell switch step completes successfully, (2) the UE determines that the L1/L2 mobility enhancement fails, (3) the UE receives an RRC message for the RRC pre-configuration step (e.g., when an RRC pre-configuration step begins), (4) the UE falls back to an L3 HO, and (5) the UE transmits an indicator or a scheduling request to inform the failure of cell switch step or to request a resource.

In some implementations, in a case that the UE fails to decode the subsequent cell switch command (or MAC CE), the UE may determine that the subsequent cell switch step fails. In some implementations, if a UE fails to receive (or decode) the subsequent cell switch command (or MAC CE) from the source gNB/cell or the previous selected target cell successfully, the UE may request that the source gNB/cell or the previous selected target cell retransmits the subsequent cell switch command (or MAC CE). In some implementations, if a UE receives (or decodes) a subsequent cell switch command (or MAC CE) successfully, the UE may transmit HARQ-ACK information (e.g., ACK) to the source gNB/cell, the previous selected target cell, or the current selected target cell.

If the UE fails to receive a confirmed information from the current selected target cell, the UE may determine that the subsequent cell switch step or the L1/L2 mobility enhancement fails. The confirmed information may include the information transmitted from the current selected target cell that informs the UE that the (subsequent) cell switch is completed. The confirmed information may be L1 signaling or L2 signaling (e.g., HARQ ACK/NACK). In some implementations, the previous selected target cell may be the one of the candidate target cells indicated in the first (or previous) cell switch command (or MAC CE) transmitted by the source gNB/cell (or the previous selected target cell). The current selected target cell may be the one of the candidate target cells indicated in the subsequent cell switch command (or MAC CE) transmitted by the first selected target cell or the source gNB/cell.

In some implementations, the UE may be configured with a counter value corresponding to the situation that the UE fails to successfully decode the subsequent cell switch command (or MAC CE). The counter value may be configured by the source gNB/cell via RRC signaling or may be predefined. When the UE fails to decode the received MAC CE (e.g., subsequent cell switch command) during subsequent cell switch step in the L1/L2 mobility enhancement and/or when the UE fails to receive (or decode or detect) the DCI scheduling the PDSCH carrying the subsequent cell switch command within a time window, the UE may increase the value of a counter by one. When the value of the counter reaches the counter value, the UE may determine that the subsequent cell switch step fails.

In some implementations, once the UE determines that the subsequent cell switch step fails, the UE may further determine that the L1/L2 mobility enhancement fails. In some implementations, the UE may switch to an L3 HO (e.g., a CHO, a DAPS, or a legacy HO) when one or more of the following conditions occur: (1) the UE determines that the subsequent cell switch step fails and (2) the UE indicates to the source gNB/cell or the previous selected target cell that the subsequent cell switch step fails via L1 signaling or L2 signaling (e.g., a MAC CE or a HARQ ACK/NACK). In some implementations, after the UE indicates the failure of the subsequent cell switch step to the source gNB/cell or the previous selected target cell, the UE may receive an RRC reconfiguration message for a legacy HO, a CHO or a DAPS.

In some implementations, the UE may reset the counter when one or more of the following conditions occur: (1) the UE successfully receives the subsequent cell switch command (or MAC CE), (2) the UE determines that the L1/L2 mobility enhancement fails, (3) the UE switches to the L3 HO procedure, (4) the UE determines that subsequent cell switch step fails, (5) the UE transmits an indicator or a scheduling request to inform the failure of subsequent cell switch step or to request a resource, and (6) the UE receives the RRC reconfiguration message including the information for an L3 HO.

In some implementations, when performing a subsequent cell switch in an LTM procedure, the UE may attempt to detect a DCI format with a CRC scrambled by an RNTI within a time window. The DCI may schedule the PDSCH carrying the subsequent cell switch command. It is noted that the DCI format may be a DL DCI format (e.g., DCI format 1_0, DCI format 1_1) and the RNTI may be a C-RNTI, a MCS-C-RNTI, a CS-RNTI, an RA-RNTI, and/or an L1/L2-mobility-specific RNTI. The UE may be configured with the L1/L2-mobility-specific RNTI by the source gNB/cell via RRC signaling. For example, the L1/L2-mobility-specific RNTI may be included in the RRC pre-configuration in L1/L2 mobility. The L1/L2-mobility-specific RNTI may be predefined. In addition, it is noted that the time window may start at the first symbol of the earliest CORESET that the UE is configured to receive a PDCCH for a search space set, where the earliest CORESET may start at least one symbol after the last symbol of the slot used to transmit the ACK to the first selected target cell or the source gNB/cell. That is, the time window may start after the last symbol of the slot used to transmit the ACK to the first selected target cell or the source gNB/cell. The search space set may be a CSS set (e.g., a Type-1 PDCCH CSS set or a Type-1A PDCCH CSS set), an USS set, and/or an L1/L2-mobility-specific search space set. The search space (set) may be configured via RRC signaling. The search space (set) configuration may be included in the RRC pre-configuration in L1/L2 mobility.

In some implementations, the UE may transmit a request to the source gNB/cell or the previous selected target cell for a subsequent cell switch command (or MAC CE) retransmission when one or more of the following conditions occur: (1) the UE fails to receive (or decode) the subsequent cell switch command (or MAC CE) successfully, (2) the UE fails to receive (or decode or detect) the DCI scheduling the PDSCH carrying the subsequent cell switch command within a time window, and (3) the UE fails to receive (or decode) the cell switch command (or MAC CE) successfully. In some implementations, the UE may transmit a HARQ ACK indicator (e.g., NACK) corresponding to the subsequent cell switch command (or MAC CE) reception to the source gNB/cell or the previous selected target cell to request a subsequent cell switch command retransmission.

In some implementations, when a timer associated with the subsequent cell switch step expires, the UE may determine that the subsequent cell switch step fails. In some implementations, when the timer associated with the subsequent cell switch step expires, the UE may transmit an indicator (e.g., HARQ-ACK information, a NACK, a MAC CE including one or more field(s) used to indicate that the subsequent cell switch step is unsuccessful, or a MAC CE including one or more field(s) used to indicate to fallback to an L3 HO) to indicate the unsuccessful completion of LTM to the source serving cell/gNB.

In some implementations, once the UE determine that the subsequent cell switch step fails, the UE may further determine that the L1/L2 mobility enhancement fails. It is noted that the UE may receive a timer value for the timer associated with the subsequent cell switch step via an RRC message (e.g., an RRC message received in the RRC pre-configuration step or an RRC reconfiguration message) or via a MAC CE from the serving cell/gNB. The UE may set the timer associated with the subsequent cell switch step with the timer value associated with the timer when one or more of the following conditions occur: (1) the UE receives the timer value, (2) the UE receives the timer value during RRC pre-configuration step, (3) the UE completes the RRC pre-configuration successfully, (4) the UE completes L1 measurement and reporting successfully, (5) the UE completes DL synchronization (before the cell switch) successfully, (6) the UE completes UL synchronization (before the cell switch) successfully, (7) the (subsequent) cell switch is triggered or begins, (8) the L1/L2 mobility enhancement is triggered, and (9) the UE receives the cell switch command from the serving cell/gNB.

The UE may (re) start the timer associated with the subsequent cell switch step with the timer value associated with the timer when one or more of the following conditions occur: (1) the UE sets the timer associated with the subsequent cell switch step, (2) the UE receives the timer value, (3) the UE receives the cell switch command from the serving cell/gNB for the first time after an RRC pre-configuration step, (4) the UE completes the RRC pre-configuration successfully, (5) the UE completes L1 measurement and reporting successfully, (6) the UE completes DL synchronization (before the cell switch) successfully, (7) the UE completes UL synchronization (before the cell switch) successfully, (8) the (subsequent) cell switch is triggered or begins, and (9) the L1/L2 mobility enhancement is triggered.

The UE may stop the timer associated with the subsequent cell switch step when one or more of the following conditions occur: (1) the subsequent cell switch step completes successfully, (2) the UE determines that the L1/L2 mobility enhancement fails, (3) the UE receives an RRC message for the RRC pre-configuration step (e.g., when an RRC pre-configuration step begins), (4) the UE falls back to an L3 HO, and (5) the UE transmits an indicator or a scheduling request to inform the failure of subsequent cell switch step or to request a resource.

### Success Determination

The UE may determine that the RRC pre-configuration step completes successfully when one or more of the following conditions occur: (1) the UE decodes the content of RRC message(s) received in the RRC pre-configuration step successfully, (2) the UE stores the content of RRC message(s) received in the RRC pre-configuration step successfully, and (3) the UE applies the content of RRC message(s) received in the RRC pre-configuration step successfully.

The UE may determine that the cell switch step completes successfully when one or more of the following conditions occur: (1) the UE receives the cell switch command successfully, (2) the UE decodes the content in the cell switch command successfully, (3) the UE applies the content in the cell switch command successfully, (4) the UE successfully switches to the target cell indicated in the cell switch command, (5) the UE successfully transmits UL data/signaling to the target cell indicated in the cell switch command, (6) the UE successfully receives DL data/signaling from the target cell indicated in the cell switch command, (7) the UE successfully performs UL synchronization to the target cell indicated in the cell switch command, (8) the UE successfully completes the RA procedure with the target cell indicated in the cell switch command, and (9) the UE successfully transmits an indicator to indicate that the success of the cell switch step.

The UE may determine that the L1 measurement and reporting completes successfully when one or more of the following conditions occur: (1) the UE successfully receives the measurement configuration from the serving cell/gNB, (2) the UE successfully applies the measurement configuration, (3) the UE successfully receives the report configuration from the serving cell/gNB, and (4) the UE successfully reports the measurement results to the serving cell/gNB.

The UE may determine that DL synchronization (before the cell switch) completes successfully when one or more of the following conditions occur: (1) the UE successfully receives the DL synchronization signals from the candidate target cells before the cell switch, (2) the UE successfully receives at least one DL synchronization signal associated with one candidate target cell from the one candidate target cell before the cell switch, (3) the UE successfully receives the DL synchronization signal from the target cell after the cell switch, (4) the UE successfully receives at least one DL synchronization signal associated with at least one candidate target cell(s) from the serving (, or source) cell/gNB, and (5) the UE successfully transmits an indicator to indicate that the success of the DL synchronization step.

The UE may determine that UL synchronization (before the cell switch) completes successfully when one or more of the following conditions occur: (1) the UE successfully receives the UL synchronization information associated with all candidate target cells from the all candidate target cells before the cell switch, (2) the UE successfully receives at least one piece of UL synchronization information associated with one candidate target cell from the one candidate target cell before the cell switch, (3) the UE successfully receives the UL synchronization information associated with the target cell from either the source serving cell/gNB or the target cell/gNB after the cell switch, (4) the UE successfully applies the UL synchronization information associated with the target cell and is successfully UL synchronous to the target cell, and (5) the UE successfully transmits an indicator to indicate that the success of the UL synchronization step.

The UE may determine that the subsequent cell switch step completes successfully when one or more of the following conditions occur: (1) the UE completes at least one cell switch step including the first cell switch per RRC pre-configuration, (2) the UE completes at least two cell switch steps including the first cell switch per RRC pre-configuration, (3) the UE completes at most a number of allowed subsequent cell switches, (4) the UE completes at least one cell switch, and (5) the UE transmits an indicator associated with at least one target cell. In some implementations, a counter value may refer to the maximum number of subsequent cell switches (including the first cell switch per RRC pre-configuration) per RRC pre-configuration that the UE is allowed to perform.

In some implementations, the UE may receive the counter value in an RRC message (e.g., an RRC message received in the RRC pre-configuration step or an RRC reconfiguration message) or in a MAC CE (e.g., in a cell switch command) from the source serving cell/gNB. The counter value may be predefined. The UE may set a counter to the counter value when one or more of the following conditions occur: (1) the UE receives the counter value, (2) the UE starts the first cell switch per RRC pre-configuration, (3) the UE receives the first cell switch command, and (4) the UE is configured with subsequent cell switch. The UE may decrease the counter by one when the UE successfully completes a cell switch. The UE may reset the counter to zero when one or more of the following conditions occur: (1) the first cell switch fails, (2) the subsequent cell switch fails, (3) any cell switch fails, and (4) the UE receive an RRC message for a new RRC pre-configuration step.

### Failure Handling

When the UE determines that the L1/L2 mobility enhancement fails (e.g., at least one of the RRC pre-configuration step, the L1 measurement and reporting step, the DL synchronization step, the UL synchronization step, the cell switch step, and the subsequent cell switch step fails), the UE may perform one or more of the following actions: (1) ignoring the newly received configurations in the RRC message or in the MAC CE, (2) applying the previously stored configurations, (3) initiating an RRC (connection) re-establishment procedure with the source serving cell/gNB, (4) determining whether the AS security has been activated, (5) performing beam failure recovery procedures, (6) transitioning into the RRC_IDLE state, (7) performing cell reselection procedure, (8) reporting the failure to the source serving cell/gNB, (9) resetting the counter to the stored counter value, (10) resetting the counter to zero, (11) stopping the timer associated with the RRC pre-configuration step, (12) stopping the timer associated with the cell switch step, (13) stopping the timer associated with the subsequent cell switch step, (14) applying the backup candidate target cell in the cell switch command, (15) falling back to an L3 HO, (16) requesting a resource for reporting the L1 measurement results, (17) reporting the measurement results on next available resources (e.g., till next periodicity), and (18) receiving the RRC reconfiguration including the information for an L3 HO.

In some implementations, when the UE (e.g., in the NR standalone mode, in NR-DC, or in NE-DC) receives the RRC message for RRC pre-configuration step in the L1/L2 mobility enhancement via the source serving cell/gNB (e.g., an NR gNB), the UE may further determine (1) whether the UE is able to decode the RRC message, (2) whether the RRC message passes the validity and/or compliance check, and/or (3) whether the UE is able to comply with (part of) the configuration included in the RRC message.

In some implementations, if the UE determines that the RRC pre-configuration step fails and/or the L1/L2 mobility enhancement fails, the UE may continue using the RRC pre-configuration that was in use for the L1/L2 mobility enhancement before the UE receives an RRC message for a new RRC pre-configuration. If the UE does not have stored RRC pre-configuration for the L1/L2 mobility enhancement and/or when the UE has released the previously stored RRC pre-configuration for the L1/L2 mobility enhancement, the UE may further determine whether the AS security has been activated. If the AS security has not been activated, the UE may perform certain actions upon transitioning to the RRC_IDLE state. Furthermore, the AS layer of the UE may transmit a release cause ‘other’, ‘RRC reconfiguration failure’ or ‘LTM failure’ to the NAS layer of the UE. If the AS security has been activated but SRB2 and at least one DRB has not been setup, the UE may perform certain actions upon transitioning to the RRC_IDLE state. Furthermore, the AS layer of the UE may transmit a release cause ‘other’, ‘RRC reconfiguration failure’ or ‘LTM failure’ to the NAS layer of the UE. If the AS security has been activated, the UE may initiate an RRC (connection) re-establishment procedure and end the LTM procedure.

In some implementations, if the UE does not support an LTM procedure or does not comprehend the configuration related to the RRC pre-configuration and/or the LTM procedure in the RRC message, the UE may ignore the configuration. For example, once the configuration is ignored by the UE, the UE may not take any action for the configuration and/or does not store the configuration.

In some implementations, if the UE determines that at least one of the RRC pre-configuration step, the cell switch step, the L1 measurement and reporting step, the DL synchronization step, the UL synchronization step, the subsequent cell switch step, and the L1/L2 mobility enhancement fails, the UE may transmit an RRC message (e.g., an LTM failure information message) including LTM failure information to the source serving cell/gNB. The UE may transmit the RRC message via SRB1. The RRC message may include the failure type, e.g., in ENUMERATED format. The failure type (e.g., the cause of LTM failure) may include, but is not limited to, the failure of the RRC pre-configuration step, the failure of the cell switch step, the failure of the L1 measurement and reporting step, the failure of the DL synchronization step, the failure of the UL synchronization step, the failure of the subsequent cell switch step, the failure of the L1/L2 mobility enhancement, the timer expiry, the failure of the RRC reconfiguration for the RRC pre-configuration step, and the RA problem. The timer expiry may refer to at least one of the following: the expiry of the timer associated with the RRC pre-configuration step, the expiry of the timer associated with the cell switch step, the expiry of the timer associated with the L1 measurement and reporting step, the expiry of the timer associated with the DL synchronization step, the expiry of the timer associated with the UL synchronization step, the expiry of the timer associated with the subsequent cell switch step, and the expiry of the timer associated with L1/2 mobility enhancement.

The UE may set the content of the failure type in the RRC message (e.g., LTM failure information message) and forward the RRC message to the lower layer (e.g., the MAC layer and/or the PHY layer) for transmission to the serving cell/gNB. Upon receiving the RRC message including the failure type, the source serving cell/gNB may perform certain actions to deal with the LTM failure. For example, the source serving cell/gNB may transmit a new RRC message (e.g., indicating a new set of candidate target cells) for triggering a new RRC pre-configuration step and/or trigger an L3 HO procedure.

In some implementations, if the UE determines that at least one of the RRC pre-configuration step, the cell switch step, the L1 measurement and reporting step, the DL synchronization step, the UL synchronization step, the subsequent cell switch step, and the L1/L2 mobility enhancement fails, the UE may transmit L1 signaling or L2 signaling (e.g., the UCI, the HARQ ACK/NACK, the CSI, the SR) including LTM failure information to the source serving cell/gNB. The L1 signaling or L2 signaling may include the information of the failure type, where the information may be in a bitmap format. For example, each bit in the bitmap may correspond to a failure type. When a bit is set to a first value (e.g., ‘1’), it indicates that the corresponding failure type has occurred. Conversely, if a bit is set to a second value (e.g., ‘0’), it means that the corresponding failure type has not occurred.

The failure types may include, but are not limited to, the failure of the RRC pre-configuration step, the failure of the cell switch step, the failure of the L1 measurement and reporting step, the failure of the DL synchronization step, the failure of the UL synchronization step, the failure of the subsequent cell switch step, the failure of the L1/L2 mobility enhancement, timer expiry, the failure of the RRC reconfiguration for the RRC pre-configuration step, and the RA problem. The timer expiry may refer to at least one of the following: the expiry of the timer associated with the RRC pre-configuration step, the expiry of the timer associated with the cell switch step, the expiry of the timer associated with the L1 measurement and reporting step, the expiry of the timer associated with the DL synchronization step, the expiry of the timer associated with the UL synchronization step, the expiry of the timer associated with the subsequent cell switch step, and the expiry of the timer associated with L1/2 mobility enhancement.

The UE may transmit the L1 signaling or L2 signaling on a PUCCH or a PUSCH to the source serving cell/gNB. Upon receiving the L1 signaling or L2 signaling including the failure type, the source serving cell/gNB may perform certain actions to deal with the LTM failure. For example, the actions may include: the source serving cell/gNB transmitting a new cell switch command for triggering a new (subsequent) cell switch step, where the new cell switch command may indicate one or more new target cells.

In some implementations, if the UE determines that at least one of the RRC pre-configuration step, the cell switch step, the L1 measurement and reporting step, the DL synchronization step, the UL synchronization step, the subsequent cell switch step, and the L1/L2 mobility enhancement fails, the lower layer of the UE may transmit internal indication to the upper layer of the UE. For example, the PHY layer (or MAC layer) of the UE may transmit (or forward) the internal indication to the RRC layer of the UE. For example, the RRC layer of the UE may transmit (or forward) the internal indication to the NAS layer of the UE. The internal indication may indicate at least one of the following: the failure of the RRC pre-configuration step, the failure of the cell switch step, the failure of the L1 measurement and reporting step, the failure of the DL synchronization step, the failure of the UL synchronization step, the failure of the subsequent cell switch step, the failure of the L1/L2 mobility enhancement, timer expiry, the failure of the RRC reconfiguration for the RRC pre-configuration step, and the RA problem. The timer expiry may refer to at least one of the following: the expiry of the timer associated with the RRC pre-configuration step, the expiry of the timer associated with the cell switch step, the expiry of the timer associated with the L1 measurement and reporting step, the expiry of the timer associated with the DL synchronization step, the expiry of the timer associated with the UL synchronization step, the expiry of the timer associated with the subsequent cell switch step, and the expiry of the timer associated with L1/2 mobility enhancement. Upon receiving the indication, the RRC layer of the UE may transmit the RRC message including the failure type to the source serving cell/gNB. Upon receiving the indication, the MAC layer of the UE may transmit the L2 signaling including the failure type to the source cell/gNB. Upon receiving the indication, the upper layer of the UE may trigger an L3 HO.

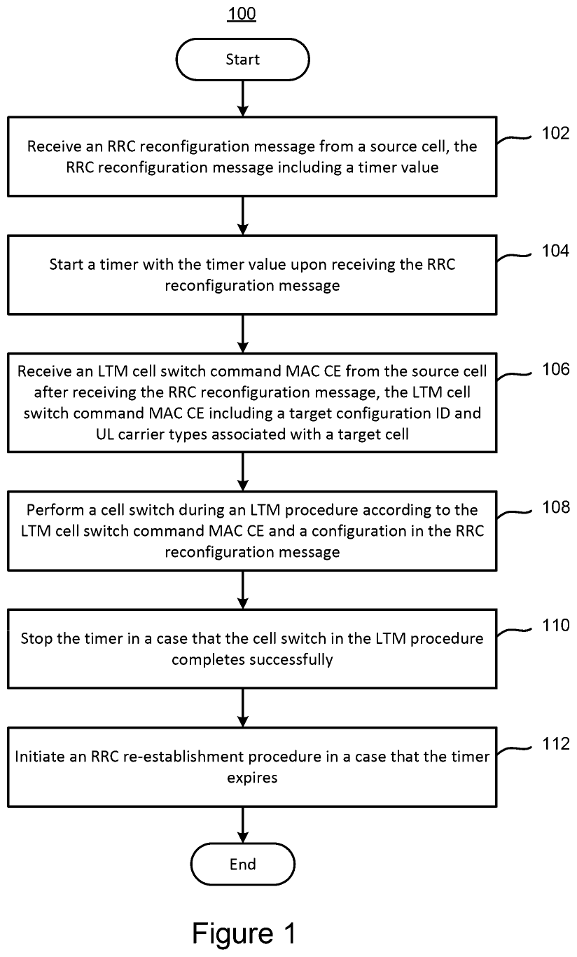

FIG. 1 is a flowchart of method 100 for enhancing mobility, according to an example implementation of the present disclosure. It should be noted that although actions 102, 104, 106, 108, 110, and 112 are illustrated as separate actions represented as independent blocks in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternate method. Moreover, each of actions 102, 104, 106, 108, 110, and 112 may be performed independently of other actions and may be omitted in some implementations of the present disclosure.

In action 102, the UE may receive an RRC reconfiguration message from a source cell.

The RRC reconfiguration message may include a timer value. It is noted that the UE may receive the RRC reconfiguration message in the RRC reconfiguration step described in the present disclosure.

In action 104, the UE may start a timer with the timer value upon receiving the RRC reconfiguration message. For example, the UE may start the timer immediately after receiving the RRC reconfiguration message, or the UE may start the timer after a predetermined period following the reception of the RRC reconfiguration message.

In action 106, the UE may receive an LTM cell switch command MAC CE from the source cell after receiving the RRC reconfiguration message. The LTM cell switch command MAC CE may include a target configuration ID and UL carrier types associated with a target cell. It is noted that the LTM cell switch command MAC CE may refer to the cell switch command (or MAC CE) described the present disclosure.

In action 108, the UE may perform a cell switch during an LTM procedure according to the LTM cell switch command MAC CE and a configuration in the RRC reconfiguration message. It is noted that the cell switch may correspond to the cell switch step described in the present disclosure.

In action 110, the UE may stop the timer in a case that the cell switch in the LTM procedure completes successfully. For example, the UE may determine that the LTM procedure or the cell switch completes successfully when certain condition(s) is met. The condition(s) may act as the stop condition of the timer.

In action 112, the UE may initiate an RRC re-establishment procedure in a case that the timer expires.

In some implementations, the LTM cell switch command MAC CE may further include at least one of the following: an RA preamble index field, information associated with a contention-free RA resource for a 4-step RA type, TA information, and information of a TCI state associated with the target cell.

In some implementations, the TCI state may be one of a DL TCI state, an UL TCI state, and a joint TCI state.

In some implementations, the UE may perform a cell reselection procedure in a case that the LTM procedure fails.

In some implementations, the UE may transition to an RRC_IDLE state in a case that the LTM procedure fails.

In some implementations, the UE may perform an RA procedure with the target cell during the LTM procedure and determine that the cell switch in the LTM procedure completes successfully in a case that the RA procedure completes successfully.

In some implementations, the UE may perform the RA procedure with the target cell on an UL carrier indicated by the UL carrier types. In some implementations, during the RA procedure, the UE may transmit an RA preamble indicated by the RA preamble index field in the LTM cell switch command MAC CE.

In some implementations, the UE may determine that the cell switch in the LTM procedure completes successfully in a case that the UE receives DL signaling from the target cell.

According to method 100, precise timing control for cell switching in the LTM procedure is enabled. This improves synchronization and coordination between the UE and the network, ensuring timely and efficient handovers. It also aids in failure handling, as the expiration of the timer can trigger RRC re-establishment, thereby enhancing the reliability and smoothness of the LTM procedure.

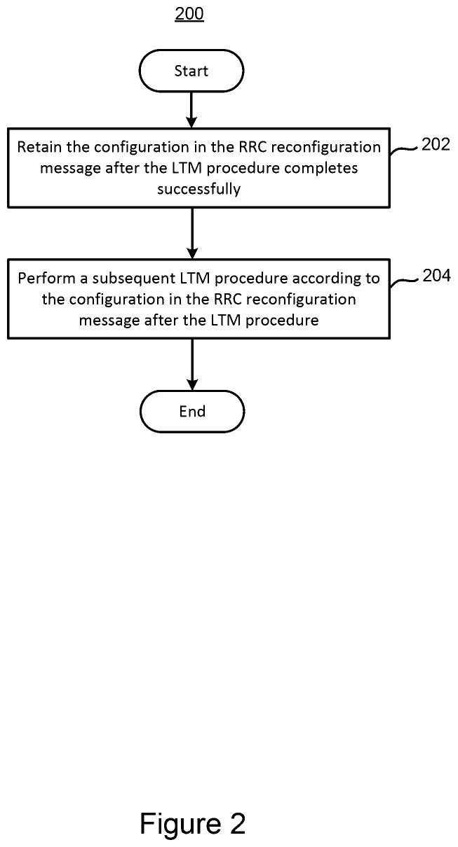

FIG. 2 is a flowchart of method 200 for enhancing mobility, according to an example implementation of the present disclosure. Method 200 can be seen as either a continuation of the earlier mentioned methods, including method 100, with additional detailed actions for mobility enhancement, or as a standalone approach offering a different or more detailed way to enhance mobility. Moreover, method 200 can be integrated with method 100 and/or other methods described in the present disclosure. Additionally, method 200 uses terminology that is consistent with or corresponds to the terminology utilized in method 100.

In action 202, the UE may retain the configuration in the RRC reconfiguration message after the LTM procedure completes successfully.

In action 204, the UE may perform a subsequent LTM procedure according to the configuration in the RRC reconfiguration message after the LTM procedure.

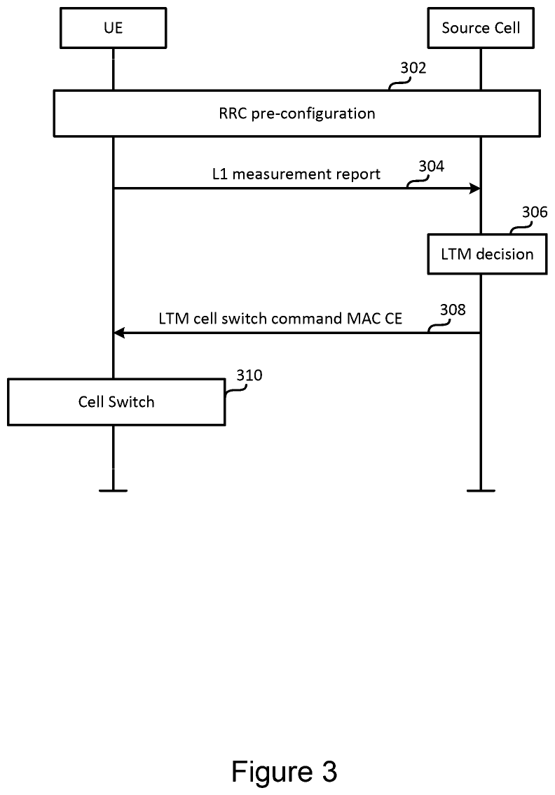

FIG. 3 is a diagram illustrating the signaling exchange between a UE and a source cell (e.g., a gNB) for an LTM procedure, according to an example implementation of the present disclosure.

In action 302, an RRC pre-configuration is performed. For example, the UE may receive an RRC reconfiguration message including a timer value during the RRC pre-configuration (e.g., corresponding to action 102 of FIG. 1). It is noted that the RRC pre-configuration may correspond to the RRC pre-configuration step described in the present disclosure.

The RRC pre-configuration may be followed by an L1 measurement and reporting step as described in the present disclosure. As illustrated in action 304, during the L1 measurement and reporting step, the UE may perform L1 measurements on the certain candidate target cell(s) and transmit one or more L1 measurement reports to the source cell.

In action 306, the source cell may determine whether to trigger an (LTM) cell switch for the UE to change the UE's serving cell, according to the L1 measurement report(s) from the UE.

In action 308, the source cell may transmit an LTM cell switch command MAC CE to the UE (e.g., corresponding to action 106 of FIG. 1), in a case that the source cell determines that the cell switch is needed to be triggered. It is noted that the transmission of the LTM cell switch command MAC CE may be part of the cell switch in the cell switch step described in the present disclosure. The LTM cell switch command MAC CE may include information for the UE to perform the cell switch. For example, the LTM cell switch command MAC CE may include a target configuration ID (e.g., indicating a configuration associated with the target cell in the received RRC reconfiguration message), the UL carrier types associated with the target cell, among others.

In action 310, the UE may perform the cell switch according to the LTM cell switch command MAC CE and the RRC reconfiguration message (e.g., corresponding to action 108 of FIG. 1).

It should be noted that not all aspects of the LTM procedure are illustrated in FIG. 3. For example, the UE and the source cell may also perform DL and UL synchronizations in the LTM procedure. Failure determination and success determination may also be performed. Additionally, the UE may perform failure handling if the UE determines that a failure has occurred in one or more of the actions/steps of the LTM procedure.

It should also be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception.

Furthermore, for certain operations, both the UE and the BS may have a mutual understanding of the timer operations. For example, the BS may anticipate, expect, or determine when the UE starts a timer and when the timer is expected to expire or stop. This synchronized understanding allows for coordinated actions, ensuring that the network and UE are in sync for critical operations, such as handover or reconfiguration.

For example, when viewed from the BS's perspective, method 100 in FIG. 1 may correspond to a method performed by a BS for enhancing mobility. The BS may transmit an RRC reconfiguration message including a timer value to a UE, enabling the UE to start a timer with the timer value upon receiving the RRC reconfiguration message. The BS may further transmit an LTM cell switch command MAC CE to the UE after transmitting the RRC reconfiguration message, enabling the UE to perform the following actions: performing a cell switch during an LTM procedure according to the LTM cell switch command MAC CE and a configuration in the RRC reconfiguration message, stopping the timer in a case that the cell switch in the LTM procedure completes successfully, and initiating an RRC re-establishment procedure in a case that the timer expires. The LTM cell switch command MAC CE may include a target configuration ID and UL carrier types associated with a target cell.

In some implementations, the LTM cell switch command MAC CE further includes at least one of the following: an RA preamble index field, information associated with a contention-free RA resource for a 4-step RA type, TA information, and information of a TCI state associated with the target cell. In some implementations, the TCI state is one of a DL TCI state, an UL TCI state, and a joint TCI state.

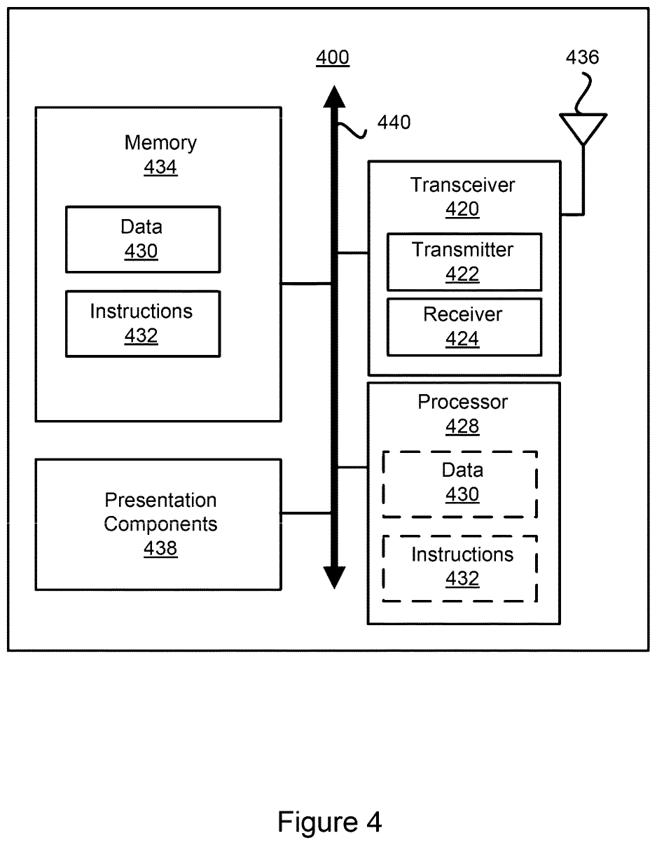

FIG. 4 is a block diagram illustrating node 400 for wireless communication in accordance with various aspects of the present disclosure. As illustrated in FIG. 4, node 400 may include transceiver 420, processor 428, memory 434, one or more presentation components 438, and at least one antenna 436. Node 400 may also include a radio frequency (RF) spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. Node 400 may be a UE or a BS that performs various functions disclosed with reference to FIGS. 1 through 3.

Transceiver 420 has transmitter 422 (e.g., transmitting/transmission circuitry) and receiver 424 (e.g., receiving/reception circuitry) and may be configured to transmit and/or receive time and/or frequency resource partitioning information. Transceiver 420 may be configured to transmit in different types of subframes and slots including, but not limited to, usable, non-usable, and flexibly usable subframes and slot formats. Transceiver 420 may be configured to receive data and control channels.

Node 400 may include a variety of computer-readable media. Computer-readable media may be any available media that may be accessed by node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 434 may include computer-storage media in the form of volatile and/or non-volatile memory. Memory 434 may be removable, non-removable, or a combination thereof. Example memory may include solid-state memory, hard drives, optical-disc drives, etc. As illustrated in FIG. 4, memory 434 may store a computer-readable and/or computer-executable instructions 432 (e.g., software codes) that are configured to, when executed, cause processor 428 to perform various functions disclosed herein, for example, with reference to FIGS. 1 through 3. Alternatively, instructions 432 may not be directly executable by processor 428 but may be configured to cause node 400 (e.g., when compiled and executed) to perform various functions disclosed herein.

Processor 428 (e.g., having processing circuitry) may include an intelligent hardware device, e.g., a Central Processing Unit (CPU), a microcontroller, an ASIC, etc. Processor 428 may include memory. Processor 428 may process data 430 and instructions 432 received from memory 434, and information transmitted and received via transceiver 420, the baseband communications module, and/or the network communications module. Processor 428 may also process information to send to transceiver 420 for transmission via antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method performed by a User Equipment (UE) for enhancing mobility, the method comprising:
receiving a Radio Resource Control (RRC) reconfiguration message from a source cell, the RRC reconfiguration message comprising a timer value;
starting a timer with the timer value upon receiving the RRC reconfiguration message;
receiving a Layer 1/Layer 2 Triggered Mobility (LTM) cell switch command Medium Access Control (MAC) Control Element (CE) from the source cell after receiving the RRC reconfiguration message, the LTM cell switch command MAC CE comprising a target configuration Identity (ID) and at least one Uplink (UL) carrier type associated with a target cell;
performing a cell switch during an LTM procedure according to the LTM cell switch command MAC CE and a configuration in the RRC reconfiguration message;
stopping the timer in a case that the cell switch in the LTM procedure completes successfully; and
initiating an RRC re-establishment procedure in a case that the timer expires.

2-9. (canceled)

10. A User Equipment (UE) for enhancing mobility, the UE comprising:
at least one processor; and
at least one non-transitory machine-readable medium coupled to the at least one processor and storing one or more computer-executable instructions that, when executed by the at least one processor, cause the UE to:
receive a Radio Resource Control (RRC) reconfiguration message from a source cell, the RRC reconfiguration message comprising a timer value;
start a timer with the timer value upon receiving the RRC reconfiguration message;
receive a Layer 1/Layer 2 Triggered Mobility (LTM) cell switch command Medium Access Control (MAC) Control Element (CE) from the source cell after receiving the RRC reconfiguration message, the LTM cell switch command MAC CE comprising a target configuration Identity (ID) and at least one Uplink (UL) carrier type associated with a target cell;
perform a cell switch during an LTM procedure according to the LTM cell switch command MAC CE and a configuration in the RRC reconfiguration message;
stop the timer in a case that the cell switch in the LTM procedure completes successfully; and
initiate an RRC re-establishment procedure in a case that the timer expires.

11. The UE of claim 10, wherein the LTM cell switch command MAC CE further comprises at least one of:
a Random Access (RA) preamble index field;
information associated with a contention-free RA resource for a 4-step RA type;
Timing Advance (TA) information; or
information of a Transmission Configuration Indicator (TCI) state associated with the target cell.

12. The UE of claim 11, wherein the TCI state is one of a Downlink (DL) TCI state, an UL TCI state, or a joint TCI state.

13. The UE of claim 10, wherein the one or more computer-executable instructions, when executed by the at least one processor, further cause the UE to:
retain the configuration in the RRC reconfiguration message after the LTM procedure completes successfully; and
perform a subsequent LTM procedure according to the configuration in the RRC reconfiguration message after the LTM procedure is completed successfully.

14. The UE of claim 10, wherein the one or more computer-executable instructions, when executed by the at least one processor, further cause the UE to:
perform a cell reselection procedure in a case that the LTM procedure fails.

15. The UE of claim 10, wherein the one or more computer-executable instructions, when executed by the at least one processor, further cause the UE to:
transition to an RRC_IDLE state in a case that the LTM procedure fails.

16. The UE of claim 10, wherein the one or more computer-executable instructions, when executed by the at least one processor, further cause the UE to:
perform a Random Access (RA) procedure with the target cell during the LTM procedure; and
determine that the cell switch in the LTM procedure completes successfully in a case that the RA procedure completes successfully.

17. The UE of claim 16, wherein performing the RA procedure with the target cell comprises:
performing the RA procedure with the target cell on an UL carrier indicated by the at least one UL carrier type.

18. The UE of claim 10, wherein the one or more computer-executable instructions, when executed by the at least one processor, further cause the UE to:
determine that the cell switch in the LTM procedure completes successfully in a case that the UE receives Downlink (DL) signaling from the target cell.

19. A Base Station (BS) for enhancing mobility, the BS comprising:
at least one processor; and
at least one non-transitory machine-readable medium coupled to the at least one processor and storing one or more computer-executable instructions that, when executed by the at least one processor, cause the BS to:
transmit a Radio Resource Control (RRC) reconfiguration message comprising a timer value to a User Equipment (UE), enabling the UE to start a timer with the timer value upon receiving the RRC reconfiguration message; and
transmit a Layer 1/Layer 2 Triggered Mobility (LTM) cell switch command Medium Access Control (MAC) Control Element (CE) to the UE after transmitting the RRC reconfiguration message, enabling the UE to:
perform a cell switch during an LTM procedure according to the LTM cell switch command MAC CE and a configuration in the RRC reconfiguration message;
stop the timer in a case that the cell switch in the LTM procedure completes successfully; and
initiate an RRC re-establishment procedure in a case that the timer expires,
wherein the LTM cell switch command MAC CE comprises a target configuration Identity (ID) and at least one Uplink (UL) carrier type associated with a target cell.

20. The BS of claim 19, wherein the LTM cell switch command MAC CE further comprises at least one of:
a Random Access (RA) preamble index field;
information associated with a contention-free RA resource for a 4-step RA type;
Timing Advance (TA) information; or
information of a Transmission Configuration Indicator (TCI) state associated with the target cell.

21. The BS of claim 20, wherein the TCI state is one of a Downlink (DL) TCI state, an UL TCI state, or a joint TCI state.
